(19) United States
(12) Patent Application Publication
(10) Pub. No.: US 2015/0325240 A1
(43) Pub. Date: Nov. 12, 2015

(54) METHOD AND SYSTEM FOR SPEECH INPUT

(71) Applicant: Alibaba Group Holding Limited, George Town (KY)

(72) Inventor: Zhining Li, Hangzhou (CN)

(21) Appl. No.: 14/703,754

(22) Filed: May 4, 2015

(30) Foreign Application Priority Data
May 6, 2014 (CN) 201410188847.7

(51) Int. Cl. G10L 15/25; G10L 15/08

(52) U.S. Cl. CPC G10L 15/25; G10L 15/08

(57) ABSTRACT

Inputting speech includes receiving feature information obtained by a client, the feature information comprising speech signals and user feature image signals, recognizing first candidate recognition data matching the user feature image signals, determining target recognition data based at least on the first candidate recognition data, and outputting the target recognition data.

### CROSS REFERENCE TO OTHER APPLICATIONS

This application claims priority to People's Republic of China Patent Application No. 201410188847.7 entitled A SPEECH INPUT METHOD, DEVICE, AND SYSTEM, filed May 6, 2014 which is incorporated herein by reference for all purposes.

### FIELD OF THE INVENTION

The present application relates to a method and system for speech input.

### BACKGROUND OF THE INVENTION

As multimedia communications and voice conversion technology develop, voice control technology (i.e., VC technology) has gained widespread attention. Having undergone rapid development, voice control technology has been used in actual applications. Example applications include using a voice to open doors and windows, raise curtains, and turn on televisions and electric lights.

One example of implementing voice control technology is speech recognition. Voice control technology is typically based on a series of user voice recognition techniques including: receiving audio signals, decomposing and filtering the audio signals based on valid speech command features, obtaining a speech sample, performing semantic recognition of the speech sample, and determining a corresponding speech command.

Current voice control technology requires clear and sharp acquisition of audio signals before the voice control technology can perform recognition. Therefore, errors can occur during voice recognition. In particular, in current voice control technology, it is very difficult to acquire user audio signals with complete accuracy when the user speaks softly or environmental noise exists.

### BRIEF DESCRIPTION OF THE DRAWINGS

Various embodiments of the invention are disclosed in the following detailed description and the accompanying drawings.

FIG. 1A is a flowchart of an embodiment of a process for speech input.

FIG. 1B is a flowchart of an embodiment of a process for recognizing first candidate recognition data matching user feature image signals.

FIG. 1C is a flowchart of an embodiment of a process for calculating a mouth-shape similarity between a frame of mouth-shape feature image signals and a frame of mouth-shape reference image signals.

FIG. 1D is a flowchart of an embodiment of a process for calculating a vector similarity of mouth-shape feature vectors to corresponding mouth-shape reference vectors.

FIG. 1E is a flowchart of an embodiment of a process for identifying second candidate recognition data matching speech signals.

FIG. 2A is a flowchart of another embodiment of a process for speech input.

FIG. 2B is a flowchart of another embodiment of a process for recognizing first candidate recognition data matching user feature image signals.

FIG. 2C is a flowchart of another embodiment of a process for calculating a mouth-shape similarity between a frame of mouth-shape feature image signals and a frame of mouth-shape reference image signals.

FIG. 2D is a flowchart of another embodiment of a process for calculating a vector similarity of mouth-shape feature vectors to corresponding mouth-shape reference vectors.

FIG. 2E is a flowchart of another embodiment of a process for identifying second candidate recognition data matching speech signals.

FIG. 3A is a structural block diagram of an embodiment of a device for speech input.

FIG. 3B is a structural block diagram of an embodiment of a first recognizing module.

FIG. 3C is a structural block diagram of an embodiment of a first mouth-shape similarity calculating module.

FIG. 3D is a structural block diagram of an embodiment of a first calculating module.

FIG. 3E is a structural block diagram of an embodiment of a second recognizing module.

FIG. 4A is a structural block diagram of another embodiment of a device for speech input.

FIG. 4B is a structural block diagram of another embodiment of a first recognizing module.

FIG. 4C is a structural block diagram of another embodiment of a first mouth-shape similarity calculating module.

FIG. 4D is a structural block diagram of another embodiment of a first calculating module.

FIG. 4E is a structural block diagram of another embodiment of a second recognizing module.

FIG. 5A is a structural block diagram of an embodiment of a system for speech input.

FIG. 5B is a structural block diagram of another embodiment of a first recognizing module.

FIG. 5C is a structural block diagram of another embodiment of a first mouth-shape similarity calculating module.

FIG. 5D is a structural block diagram of another embodiment of a first calculating module.

FIG. 5E is a structural block diagram of another embodiment of a second recognizing module.

FIG. 6 is a functional diagram illustrating an embodiment of a programmed computer system for processing speech data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

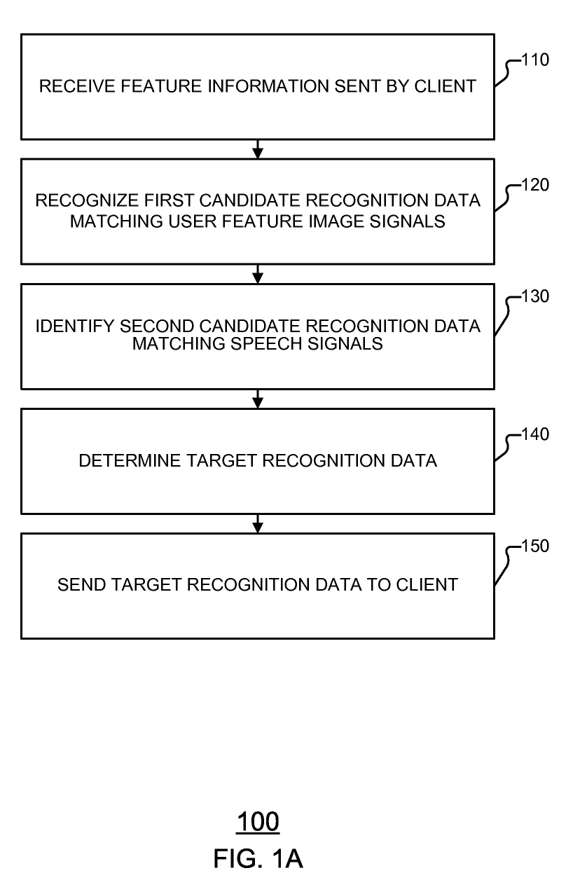

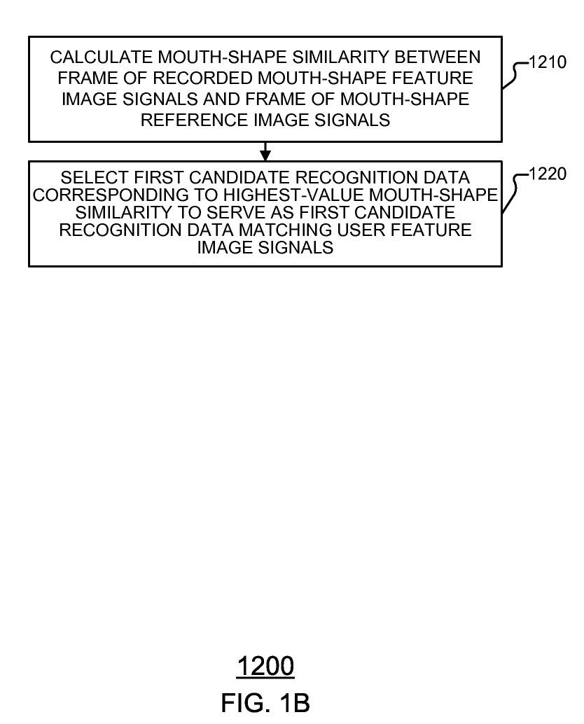

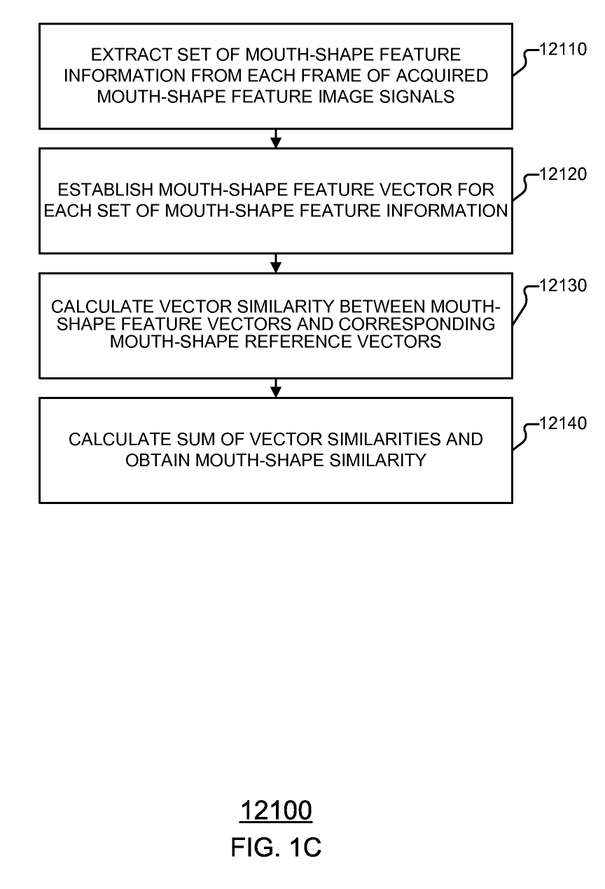

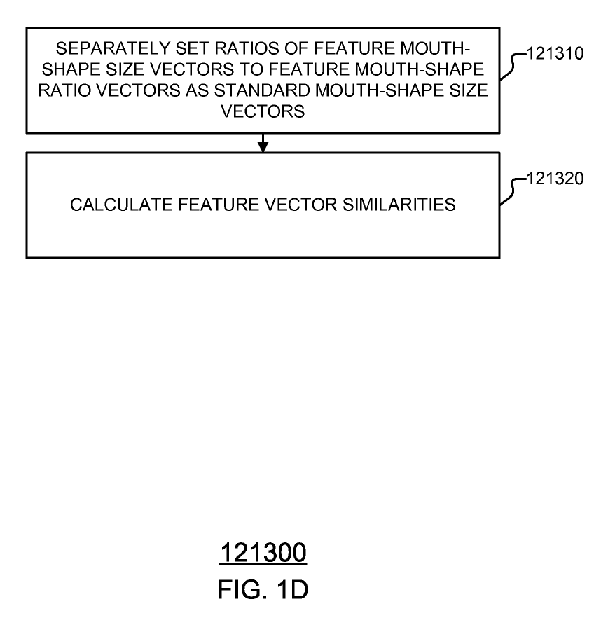

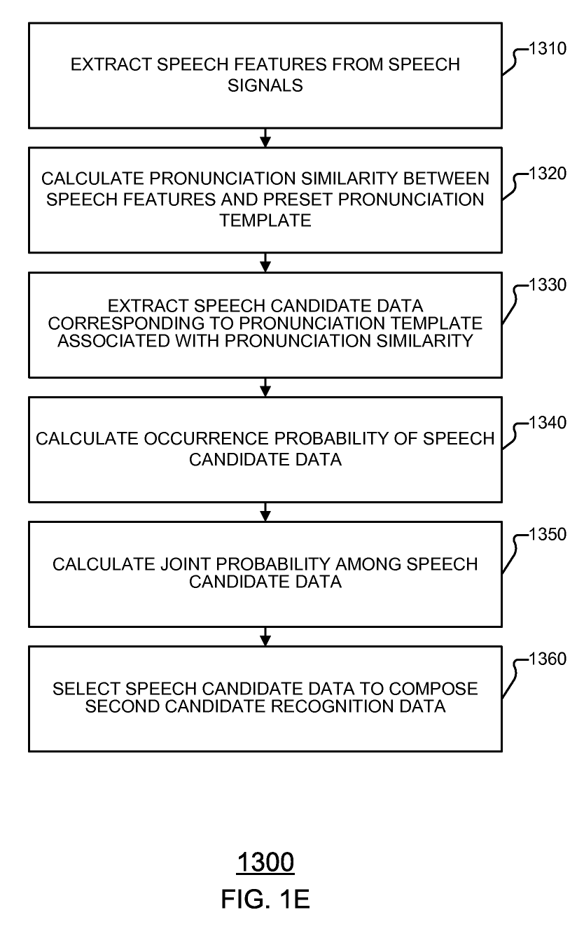

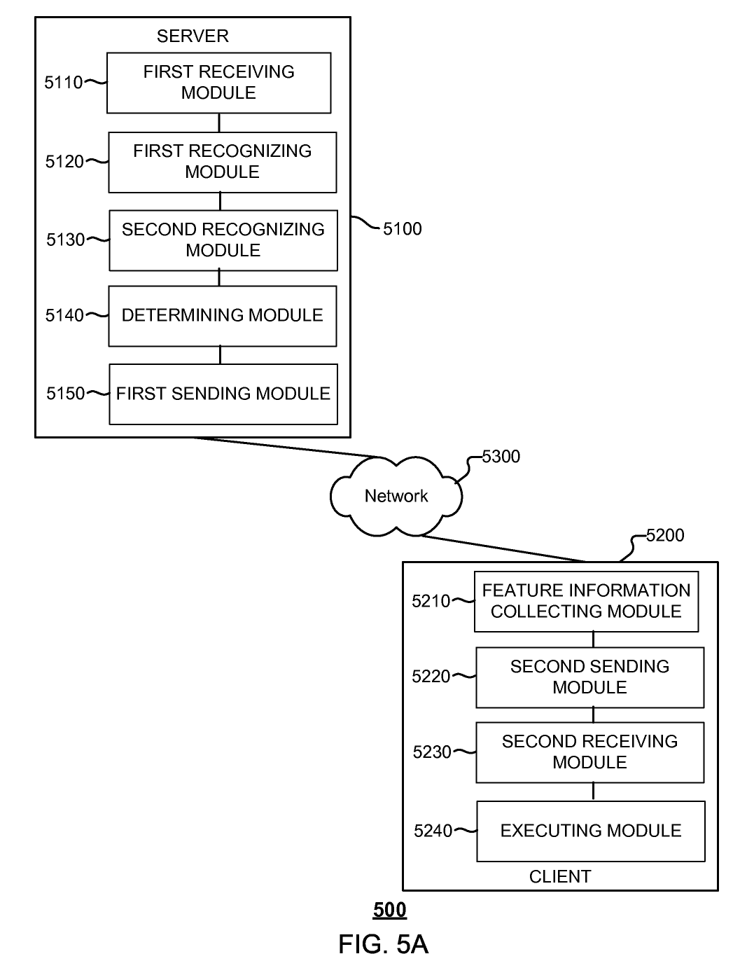

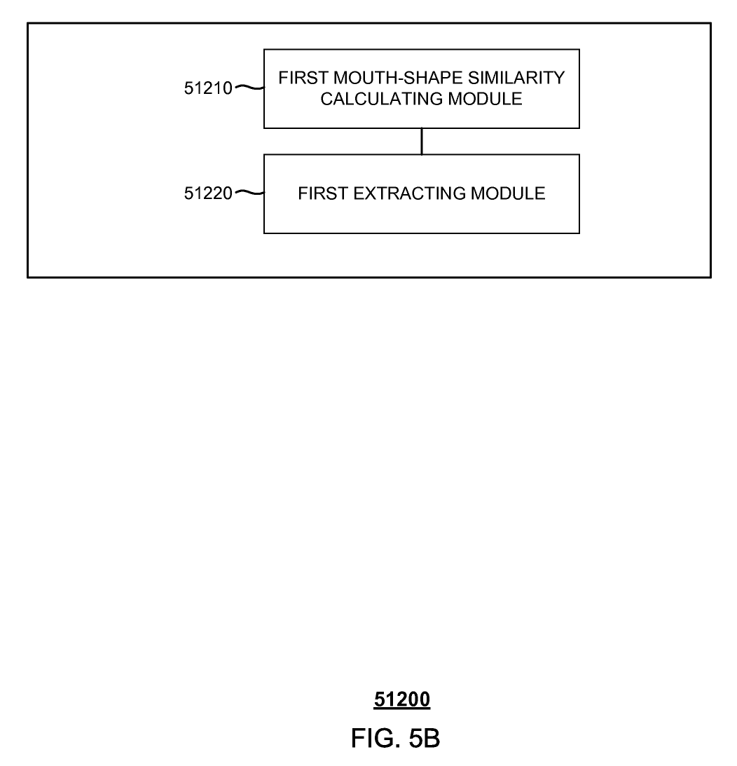

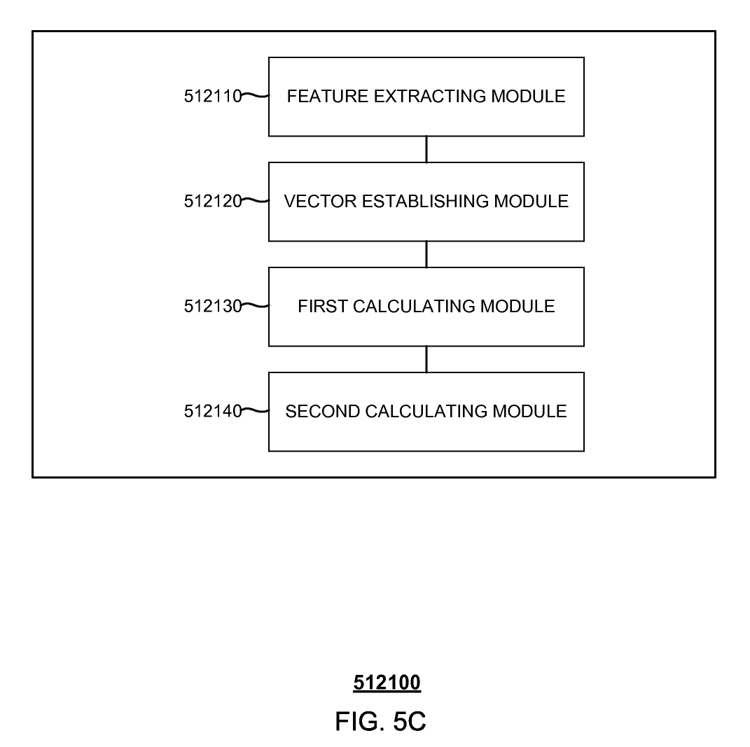

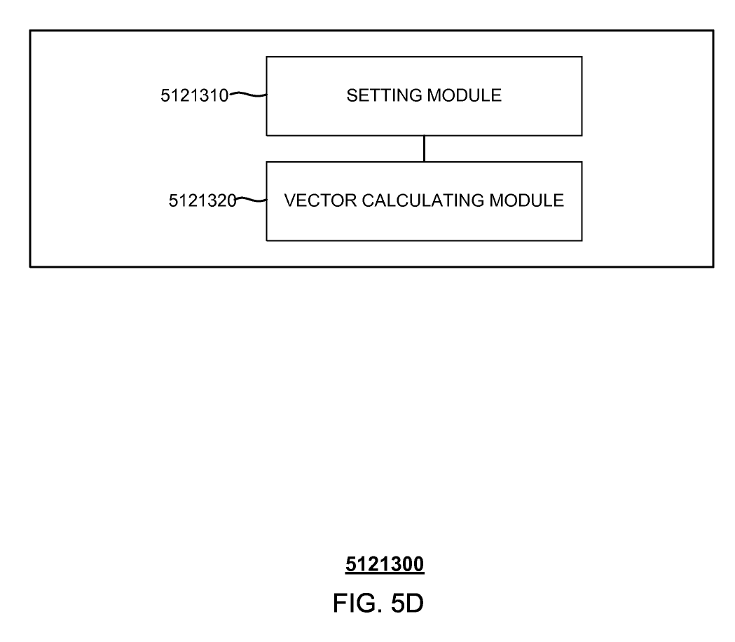

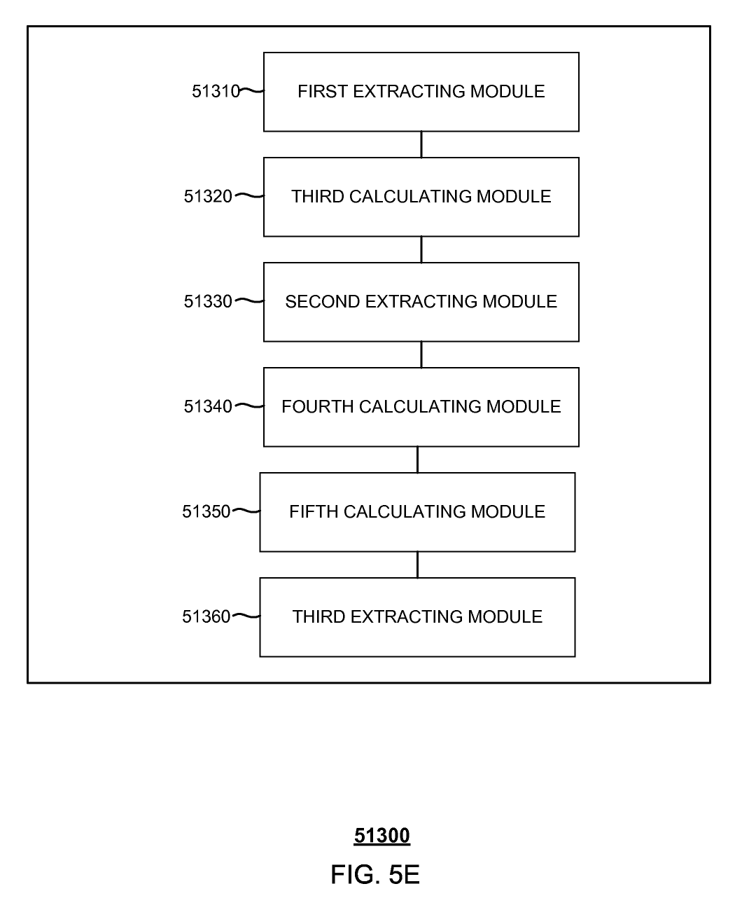

FIG. 1A is a flowchart of an embodiment of a process for speech input. In some embodiments, the process 100 is implemented by a server 5100 of FIG. 5A or by a device such as a mobile phone, a tablet, etc. In the following discussion, a server-based implementation is described, but a client-implementation is also possible in some embodiments. For example, a microphone of a mobile phone can be used as an input source for receiving speech inputs. When the microphone receives sound, the mobile phone can process the received sound for particular purposes.

In 110, the server receives feature information sent by a client, the feature information including speech signals and user feature image signals.

In some embodiments, the feature information is collected at the client as a user enters voice control operating instructions to the client. Subsequently, the collected feature information is sent to the server or a cloud comprising a plurality of servers.

In some embodiments, the speech signals correspond to signals recording speech input by the user, such as sound wave signals. For example, the speech signals are collected through audio equipment such as a microphone. In some embodiments, the user feature image signals are signals representing or recording images of anatomical features of the user, such as an image of the user's mouth, hand, etc. For example, the anatomical features are collected through video equipment such as a camera.

Please note that the speech signals and the user feature image signals can also be collected in the form of digital data. For example, the speech signals correspond to data following digitalization of analog signals collected by audio equipment such as a microphone, such as data in WAV, MP3, or other formats.

In some embodiments, the user feature image signals include one or more frames of mouth-shape feature image signals recorded when the speech signals were input, where at least one image of a user's mouth is captured.

For example, when a user inputs speech into a client device such as a mobile device, the user activates video equipment such as a camera and traces a focus frame on the screen of the mobile device. Similarly, when taking a picture with the mobile device, the user can configure the mobile phone to automatically focus onto the facial focus frame and then, using this facial focus frame, home in on the user's mouth for a real-time capture of changes in the user's mouth. Lastly, one or more frames of mouth-shape feature image signals are captured from the start of user speech signal input until the end.

In some embodiments, a quantity of user feature image signals is set based on actual conditions. For example, the quantity could be set to eight frames, which on the one hand provides convenient computation while on the other hand keeps storage requirements reasonable. Due to the use of binary systems, data computation and matching are less complex using powers of two. Therefore, eight frames require a reasonable amount of computation. If more frames are input, then more storage resources are to be used. If fewer frames are input, an accurate recognition of the candidate recognition data matched with the mouth-shape feature image signals may not be possible. Eight frames take up relatively few image resources and also perform a relatively good job of recognizing candidate recognition data matched with the mouth-shape feature image signals.

In 120, the server recognizes first candidate recognition data matching the user feature image signals. Details of the recognition are described below in connection with FIGS. 1B-1D.

To communicate, people often use body language. In other words, people use body movements or actions instead of or supplementing voice, oral speech, or other forms of communication. For example, lip language, sign language, and gestures other than sign language exist. For example, the gesture of waving a finger typically represents disapproval, rejection, etc.

Therefore, in some embodiments, meanings expressed by a user are determined from the user feature image signals.

In this example, the mouth-shape feature image signals serve as an example of the user feature image signals.

Using Chinese as an example of text information, typically two methods for reading Chinese Pinyin (the phonetic system for transcribing Chinese) out loud exist: the spell-out method (light and short initial sound, stress on the final sound) and the direct-call method (making a mouth shape for an initial consonant and then sounding out the vowels). The consonants and vowels have specific pronunciations. As a result, when a user pronounces an initial consonant and then vowels, the user's mouth shape varies. For example, when pronouncing the initial consonant “b,” the user's lips are held together to obstruct the flow of air. Then the lips are suddenly opened, allowing an explosive release of air current, and the vocal chords vibrate. Thus, the shape of the mouth has different characteristics while pronouncing different sounds in Chinese. The same is true for most other languages that have consonants and vowels.

Therefore, in some embodiments, a pre-established mouth-shape database is established. The mouth-shape database stores one or more pieces of first candidate recognition data and corresponding mouth-shape image signals. In various embodiments, the first candidate recognition data includes text information, operating instructions, and/or other appropriate information.

In some embodiments, the first candidate recognition data corresponds to mouth-shape reference image signals of one or more frames. In other words, for each piece of first candidate recognition data, a set of one or more frames (e.g., eight frames) of mouth-shape reference image signals that correspond to the changing mouth-shapes of a reference individual during the pronunciation of the text of the first candidate recognition data is to be established.

In some embodiments, each frame of the mouth-shape reference image signals corresponds to a set of mouth-shape reference vectors. These mouth-shape reference vectors are vectors recording mouth-shape features during input of the first candidate recognition data.

In some embodiments, each set of mouth-shape reference vectors includes a reference mouth-shape size vector, a reference mouth-shape ratio vector, a reference teeth visibility vector, a reference teeth ratio vector, a reference tongue visibility vector, a reference tongue ratio vector, any other appropriate vector, or any combination thereof.

In some embodiments, the reference mouth-shape size vector corresponds to a size of an area of a mouth-shape region in the mouth-shape reference image signals.

In some embodiments, the reference mouth-shape ratio vector identifies a ratio of an area of a mouth-shape region in the mouth-shape reference image signals to an area of a preset standard mouth-shape region.

In some embodiments, the reference teeth visibility vector identifies whether a teeth region has been recognized in the mouth-shape reference image signals.

In some embodiments, the reference teeth ratio vector identifies a ratio of a teeth region to a mouth-shape region in the mouth-shape reference image signals.

In some embodiments, the reference tongue visibility vector identifies whether a tongue region has been recognized in the mouth-shape reference image signals.

In some embodiments, the reference tongue ratio vector identifies a ratio of a tongue region to a mouth-shape region in the mouth-shape reference image signals.

For example, when the first candidate recognition data corresponds to “kai,” the Chinese word for “open” which involves the consonant sound “k” followed by the vowel sound “ai,” eight corresponding frames of mouth-shape reference image signals exist, for which are established a mouth-shape reference vector set comprising vectors X1 through X8, respectively, a total of eight vectors. The specific mouth-shape reference vectors can be as follows:

X1=(0, 1, 0, 0, 0, 0)

X2=(2, 1, 1, 0.5, 1, 0.2)

X3=(5, 1, 2, 0.2, 1, 0.4)

X4=(6, 1, 1, 0.1, 1, 0.5)

X5=(8, 1, 1, 0.08, 1, 0.6)

X6=(10, 1, 1, 0.05, 1, 0.7)

X7=(15, 1, 1, 0.02, 1, 0.8)

X8=(0, 1, 0, 0, 0, 0)

Using vector X2 as an example, the first vector element “2” corresponds to the reference mouth-shape size vector element, and the first vector element indicates that the mouth-shape size is 2 unit areas. The second vector element “1” corresponds to the reference mouth-shape ratio vector element, and indicates that the mouth-shape size is 1 times the standard mouth-shape (i.e., the mouth-shape size and the standard mouth-shape are the same size). The third vector element “1” corresponds to the reference teeth visibility vector element, and indicates that teeth are visible. In some embodiments, the value “0” for the third vector element is used to indicate that no teeth are visible. The fourth vector element “0.5” corresponds to the reference teeth ratio vector element, and the fourth vector element indicates that the size of visible teeth is 0.5 times the mouth-shape size. The fifth vector element “1” corresponds to the reference tongue visibility vector element, and the fifth vector element indicates that the tongue is visible. In some embodiments, the value “0” for the fifth vector element is used to indicate that the tongue is not visible. The sixth vector element “0.2” corresponds to a reference tongue ratio, and indicates that the visible tongue size is 0.2 times the mouth-shape size.

In the above example, when the user says “kai (open)” to the device, the device captures the user's sound and changes in mouth shape, translates the mouth shape changes into the eight vectors, and compares the eight vectors with reference vectors from the database to determine more precisely what the user said.

The above mouth-shape reference vector elements are merely examples. In some embodiments, other mouth-shape reference vector elements are set according to actual conditions. In some embodiments, the visibility elements are omitted and the ratio vector elements are set to a negative value or 0 if the feature is not visible.

FIG. 1B is a flowchart of an embodiment of a process for recognizing first candidate recognition data matching user feature image signals. In some embodiments, the process 1200 is an implementation of operation 120 of FIG. 1A and comprises:

In 1210, the server calculates a mouth-shape similarity between a frame of the recorded mouth-shape feature image signals and a frame of mouth-shape reference image signals.

In some embodiments, mouth-shape similarity is a similarity between the mouth shape recorded from mouth-shape feature image signals and the mouth shape recorded in mouth-shape reference image signals. In some embodiments, the similarity is measured as a distance between two vectors.

FIG. 1C is a flowchart of an embodiment of a process for calculating a mouth-shape similarity between a frame of mouth-shape feature image signals and a frame of mouth-shape reference image signals. In some embodiments, the process 12100 is an implementation of operation 1210 of FIG. 1B and comprises:

In 12110, the server extracts a set of mouth-shape feature information from each frame of the acquired mouth-shape feature image signals.

In some embodiments, extracting the set of mouth-shape feature information includes: an acquisition of mouth-shape feature information, a processing and analysis of mouth-shape feature information, and an output or a display.

In some embodiments, the acquisition of mouth-shape feature information corresponds to the conversion of visual images and internal features of mouth-shape feature information into a data series that can be processed by a computer. The acquisition of mouth-shape feature information relies on existing image processing methods to clean up the image and improve the image quality for further processing. The image processing methods include image enhancement, data coding and output, image smoothing, edge sharpening, partitioning, feature extraction, image recognition and understanding, and other known techniques. Following the image processing methods, the quality of an output image is considerably increased. In other words, visual effects of the image are modified to facilitate further computer analysis, processing, and recognition of the image.

Subsequently, color, shape, and other such information can be used to recognize environmental targets. Using a robotic recognition process as an example for color recognition: after the mouth-shape feature image signals are obtained, the pixels in the mouth-shape feature image signals are divided into two parts based on color: pixels of interest (mouth-shape feature information colors) and pixels that are not of interest (background colors). Subsequently, the pixels of interest undergo RGB (red, green, and blue) color component matching. Furthermore, to reduce the effects of ambient light intensity, an RGB color space can be converted to an HIS (hue, intensity, saturation) color space.

In some embodiments, the mouth-shape feature information includes pixel locations of pixels found to represent mouth, teeth, tongue, or any combination thereof.

Thus, in this example, after the mouth-shape feature image signals are acquired, the mouth-shape feature image signals undergo color analysis, and pixels of the image are matched based on preset feature colors. For example, those pixels found to match the preset lip, tooth, or tongue colors are deemed to represent the lips, teeth, or tongue, respectively. The lips, teeth, and tongue pixels together are also deemed to represent the entire mouth.

In 12120, the server establishes a mouth-shape feature vector for each set of mouth-shape feature information.

In some embodiments, the mouth-shape feature vector records mouth-shape features at a specific time of speech signal input (e.g., at the time that a particular image frame is taken).

In some embodiments, each mouth-shape feature vector includes a feature mouth-shape size vector element, a feature mouth-shape ratio vector element, a feature teeth visibility vector element, a feature teeth ratio vector element, a feature tongue visibility vector element, a feature tongue ratio vector element, or any combination thereof.

In some embodiments, the feature mouth-shape size vector element identifies a size of an area of the mouth-shape region in the mouth-shape feature image signals.

In some embodiments, the feature mouth-shape ratio vector element identifies a ratio of an area of the mouth-shape region in the mouth-shape feature image signals to an area of a preset standard mouth-shape region.

In some embodiments, the feature teeth visibility vector element identifies whether a teeth region has been recognized in the mouth-shape feature image signals.

In some embodiments, the feature teeth ratio vector element identifies a ratio of the teeth region to a mouth-shape region in the mouth-shape feature image signals.

In some embodiments, the feature tongue visibility vector element identifies whether a tongue region has been recognized in the mouth-shape feature image signals.

In some embodiments, the feature tongue ratio vector element identifies a ratio of a tongue region to a mouth-shape region in the mouth-shape feature image signals.

In some embodiments, after mouth-shape feature information such as that of the mouth, teeth, and tongue have been determined, directly establishing a feature mouth-shape size vector element, a feature teeth visibility vector element, and a feature tongue visibility vector element are possible. As an example, the number of mouth pixels is compared to a standard number of pixels for a standard mouth shape to establish a feature mouth-shape ratio vector element; the number of teeth pixels are compared to the number of mouth pixels to establish a feature teeth ratio vector element; and the number of tongue pixels is compared to the number of mouth pixels to establish a feature tongue ratio vector element.

For example, when a user inputs speech signals, eight frames of mouth-shape feature image signals are collected to record real-time changes in a user mouth shape. In addition, for each frame of the mouth-shape feature signals, one mouth-shape feature vector is established based on one or more predetermined mouth-shape reference vector rules as described above. Based on the eight frames, a total of eight mouth-shape feature vectors, Y1′ through Y8′, are established. Examples of the mouth-shape feature vectors include:

Y1′=(0, 2, 0, 0, 0, 0)

Y2′=(4, 2, 1, 0.5, 1, 0.2)

Y3′=(10, 2, 2, 0.2, 1, 0.4)

Y4′=(12, 2, 1, 0.1, 1, 0.5)

Y5′=(16, 2, 1, 0.08, 1, 0.6)

Y6′=(20, 2, 1, 0.04, 1, 0.7)

Y7′=(30, 2, 1, 0.02, 1, 0.8)

Y8′=(0, 2, 0, 0, 0, 0)

Using Y2′ as an example, the first vector element “4” corresponds to the feature mouth-shape size vector element, and indicates that the mouth-shape size is 4 unit areas. The second vector element “2” corresponds to the feature mouth-shape ratio vector element, and indicates that the mouth-shape size is 2 times the standard mouth shape. The third vector element “1” corresponds to the feature teeth visibility vector element, and indicates that teeth are visible. If the third vector element were “0,” it would indicate that no teeth are visible. The fourth vector element “0.5” corresponds to the feature teeth ratio vector element, and indicates that the size of visible teeth is 0.5 times the mouth-shape size. The fifth vector element “1” corresponds to the feature tongue visibility vector element, and indicates that a tongue is visible. In addition, the value “0” of the fifth vector element could indicate that the tongue is not visible. The sixth vector element “0.2” corresponds to the feature tongue ratio, and the sixth vector element indicates that the visible tongue size is 0.2 times the mouth-shape size.

In 12130, the server calculates a vector similarity between the mouth-shape feature vectors and the corresponding mouth-shape reference vectors, respectively.

In some embodiments, vector similarity calculations can be performed on a pair of mouth-shape feature vector and corresponding mouth-shape reference vector. For example, the vector similarity is calculated for Y1′ and X1 in the example above by computing the vector distance of Y1′ and X1; and the vector similarity is calculated for Y2′ and X2 by computing the vector distance of Y2′ and X2, etc. Other similarity calculations can be used.

Other similarity calculations include calculating changes in various attributes such as, for example, changes in tongue movement, changes in mouth movement, etc.

FIG. 1D is a flowchart of an embodiment of a process for calculating a vector similarity of mouth-shape feature vectors to corresponding mouth-shape reference vectors. In some embodiments, the process 121300 is an implementation of operation 12130 of FIG. 1C and comprises:

In 121310, the server separately sets the ratios of the feature mouth-shape size vector elements to the feature mouth-shape ratio vector elements as the standard mouth-shape size vector elements.

Because collection distances (e.g., how close the user's mouth is to the video recorder) are not completely the same when user feature image signals are collected, and since the size of each user's mouth shape is not completely the same, a uniform standard for feature mouth-shape size vectors is to be defined.

For example, the mouth-shape feature vectors Y1′ through Y8′ (a total of eight vectors) are converted to the mouth-shape feature vectors Y1 through Y8 (a total of eight vectors).

Y1=(0, 1, 0, 0, 0, 0)

Y2=(2, 1, 1, 0.5, 1, 0.2)

Y3=(5, 1, 2, 0.2, 1, 0.4)

Y4=(6, 1, 1, 0.1, 1, 0.5)

Y5=(8, 1, 1, 0.08, 1, 0.6)

Y6=(10, 1, 1, 0.04, 1, 0.7)

Y7=(15, 1, 1, 0.02, 1, 0.8)

Y8=(0, 1, 0, 0, 0, 0)

In this example, the second vector element (the feature mouth-shape ratio vector element) was “2” but has been converted (normalized by dividing by 2) to “1.” The first vector element (the feature mouth-shape size vector element) is also converted (normalized by dividing by the feature mouth-shape ratio vector element). The other vector elements are unchanged. In this example, because the first vector element corresponds to the size of the mouth shape, the second vector element corresponds to the total size of the mouth, and mouths typically have different sizes, when the second vector element is normalized, the first vector element also is to be adjusted accordingly. As an aspect, the other vector elements are not related to the size of the mouth, and thus do not need to be changed.

At this point, calculating the vector similarity of Y1 and X1, and calculating the vector similarity of Y2 and X2, etc. are to be performed. For example, the vector similarity between Y1 and X1 can be computed as the vector distance between Y1 and X1.

In 121320, the server calculates feature vector similarities based on the vector elements. In some embodiments, the similarity is determined for the standard mouth-shape size vector element, the feature teeth visibility vector element, the feature teeth ratio vector element, the feature tongue visibility vector element, and the feature tongue ratio vector element relative to the reference mouth-shape size vector element, the reference teeth visibility vector element, the reference teeth ratio vector element, the reference tongue visibility vector element, and the reference tongue ratio vector element by computing the distance of the vectors (e.g., subtracting each pair of elements, squaring the differences, summing the squared results, and taking the square roots.).

In some embodiments, matching can be performed based on a regular expression.

Referring back to FIG. 1C, in 12140, the server calculates a sum of the vector similarities (e.g., a sum of eight vector similarity values) and obtains a mouth-shape similarity based on the sum of the vector similarities. This mouth-shape similarity represents the similarity between the set of obtained mouth-shapes and the set of reference mouth-shapes.

After analyzing the mouth-shape feature vectors with the corresponding mouth-shape reference vectors, the vector similarities between each group of feature vectors/reference vectors are calculated. For each set of vector similarities, the vector similarities are totaled to obtain the corresponding mouth-shape similarity. The mouth-shape similarity provides a level of similarity of the mouth-shape feature image signals to the mouth-shape reference image signals and identifies the level of mouth-shape similarity of the mouth shape of the user pronouncing these speech signals to the mouth shape pronouncing the first candidate recognition data. For example, for a given set of mouth-shape feature vectors obtained based on the eight acquired image frames, sets of vector similarities relative to sets of mouth-shape reference vectors corresponding to the pronunciations of “kai,” “ha,” “ka,” “ku,” and other candidate recognition data in the database are calculated. The sets of vector similarities are summed to generate corresponding mouth-shape similarities indicating how similar the acquired images are to the pronunciation of “kai,” “ha,” “ka,” “ku,” etc., respectively.

Referring back to FIG. 1B, in 1220, given the computed mouth-shape similarities, the server selects the first candidate recognition data corresponding to the highest-value mouth-shape similarity to serve as the first candidate recognition data matching the user feature image signals.

In some embodiments, the first candidate recognition data corresponding to the highest-value mouth-shape similarity serves as the first candidate recognition data matching the speech signals generated by the user.

It should be understood the above-described user feature image signals serve as an example only. In some embodiments, other user feature image signals, e.g., one or more frame recording gesture features of a user's hand gesture, can be used based on practical applications.

In some embodiments, a user body database is established based on user body characteristics. The database records correspondences between candidate recognition data and body reference vectors (e.g., hand/arm gesture reference vectors). As for other user feature image signals (e.g., gesture feature image signals), corresponding body feature vectors (e.g., gesture feature vectors) can be established. Similarities between body feature vectors (e.g., gesture feature vectors) and body reference vectors (e.g., gesture reference vectors) are to be calculated to obtain the candidate recognition data matching the user feature image signals (e.g., gesture image signals).

In some embodiments, the fact that mouth shapes vary with pronunciation are utilized. By recognizing changes in user mouth shape, the mouth shapes can spare the performance of extra operations and ensure ease and convenience of user operations. Also, the recognition of changes in user mouth shape further increases speech recognition accuracy.

Referring back to FIG. 1A, in 130, the server identifies second candidate recognition data matching the received speech signals.

In some embodiments, speech recognition technology is used to recognize the second candidate recognition data matched with the speech signals. The second candidate recognition data can include text information, operating instructions, or the like.

Speech recognition technology is also called automatic speech recognition (ASR). ASR is to convert lexical content in speech spoken by a person into a computer-readable version.

Currently, vocabulary speech recognition typically uses statistical model-based recognition technology, the implementation of which is known to those skilled in the art. In some embodiments, statistical model-based speech recognition includes:

1. Speech signal processing and speech feature extraction extract speech features from input speech signals. These extracted speech features are used in acoustic modeling and in decoding processes. In some embodiments, before extracting the speech features, the speech signals are subjected to noise-reduction and other such treatment to increase system robustness.

2. Statistical acoustic model—general speech recognition systems usually generate an acoustic model based on the Hidden Markov Model to model words, syllables, phonemes, and other basic acoustic units.

3. Language model models a language on a word layer that the system is to recognize. Language models include various language models with a regular language and context-independent grammar. Currently, speech recognition typically uses statistical language models. In some embodiments, the statistical language models are statistics-based N-gram models and variants thereof.

4. Pronunciation dictionary includes a set of words capable of being processed and provides their pronunciation. Mapping relationships between acoustic model modeling units and language model modeling units are obtained via the pronunciation dictionary. The acoustic model is thus joined to the language model to form a search state space for decoder to perform decoding operations.

5. The decoder is one of the cores of speech recognition. The decoder reads speech feature series and performs decoding in the state spaces generated by acoustic models, language models, and pronunciation dictionaries to determine word strings with the maximum probability of outputting the speech signals.

FIG. 1E is a flowchart of an embodiment of a process for identifying second candidate recognition data matching speech signals. In some embodiments, the process 1300 is an implementation of operation 130 of FIG. 1A and comprises:

In 1310, the server extracts speech features from the speech signals.

In 1320, the server calculates a pronunciation similarity between the speech features and a preset pronunciation template.

In 1330, in the event that the pronunciation similarity is greater than a preset similarity threshold value, the server extracts speech candidate data corresponding to the pronunciation template associated with the pronunciation similarity.

The acoustic model is a part of speech recognition. The acoustic model is also one component in speech recognition. The quality of acoustic modeling affects speech recognition results and robustness.

An experimental probability statistical acoustic model models basic speech units including acoustic information and describes their statistical characteristics. By modeling an acoustics model, one can effectively measure a similarity between speech feature vectors series and each pronunciation template. The acoustics model can help in determining acoustic information of a segment of speech, i.e., the speech content. All of a speaker's speech content includes some basic speech units. These basic speech units correspond to sentences, phrases, words, syllables, sub-syllables, or phonemes. Many speech units exist that can be selected for modeling. Typically, selecting speech units for modeling should be based on specific application scenarios.

In small-vocabulary speech recognition, a word is typically selected as a speech unit for establishing acoustic models.

In large-vocabulary continuous recognition (LVCSR), phonemes are typically selected as modeling units, and typically two different approaches to modeling that involve phoneme selection exist: phoneme context-independent modeling and context-dependent modeling.

In 1340, the server calculates an occurrence probability of the speech candidate data.

In some embodiments, the occurrence probability corresponds to a probability that the speech candidate data appears in speech. Because of a change over time, noise, and other unstable factors relating to speech signals, achieving high speech recognition accuracy rates by simply relying on acoustic models is very unlikely. In human language, the words in each sentence are directly and closely related. This information at the word layer can reduce the scope of acoustic model searches and effectively increase recognition accuracy. To complete this task, a language model is used. The language model provides context information and semantic information between words in speech.

As statistical language processing methods develop, statistical language models are a technique for language processing in speech recognition. Many such statistical language models exist, such as N-gram language models, a Markov N-gram model, exponential models, and decision tree models. The N-gram language models, for example, bigram and trigram language models, are commonly used statistical language models.

Using a trigram language model as an example, assume that “wi” corresponds to any word in some text. If the two preceding words in the text are “wi-2wi-1” and are already known, the conditional probability P (wi|wi-2wi-1) can be used to predict the probability that “wi” will occur. This is the concept of an N-gram language model. If the variable W is used to represent a series of words in text, i.e., W=w1 w2 . . . wn, the statistical language model is used to calculate the probability, P(W), that W will occur under the language model.

In 1350, in the event that the occurrence probability is greater than a preset first probability threshold value, the server calculates a joint probability among the speech candidate data.

In some embodiments, pronunciations of all words are placed in a pronunciation dictionary which connects an acoustic model and a language model. For example, a sentence is broken apart into a number of words that are connected together. A phoneme series can be obtained for each word by looking each word up in the pronunciation dictionary. Adjacent word shift probabilities can be obtained through a language model. The phoneme probability model can be obtained through an acoustic model. A probability model, i.e., a joint probability of the words in the sentence, can thus be generated for the sentence. As an example, a sentence is formed by multiple words, and each word is formed by multiple syllables. The joint probability is used to identify these combinations.

In 1360, in the event that the joint probability is greater than a preset second probability threshold value, the server selects the speech candidate data to compose second candidate recognition data.

Because the user speaks softly, external environmental noise, or other such factors, one or more pieces of second candidate recognition data that are recognized can exist.

Referring back to FIG. 1A, in 140, the server determines target recognition data based at least on the first candidate recognition data and the second candidate recognition data.

In some embodiments, the target recognition data is text information, operating instructions, etc.

In some embodiments, the determining of the target recognition data includes performing intersection processing on the first candidate recognition data and the second candidate recognition data to obtain the target recognition data.

In some embodiments, the intersection of the first candidate recognition data and the second candidate recognition data corresponds to the target recognition data.

For example, the user inputs the speech signal “kai.” In operation 120, mouth-shape feature vectors Y1′ through Y8′ are established for the collected user mouth-shape feature image signals. Then the mouth-shape feature image signals are converted to standard mouth-shape feature vectors Y1 through Y8 and matched with mouth-shape reference vectors from a mouth-shape database. The highest similarity of mouth-shape feature vectors Y1 through Y8 matched with mouth-shape reference vectors X1 through X8, i.e., the match result, is “kai” corresponding to X1 through X8. In operation 130, because the user is speaking more softly, external environmental noise exists, or some other such factor, the acoustic model and language model match results are “kai,” “ha,” and “ka.” Lastly, further matching is performed based on the match results of operations 120 and 130 to obtain the intersection of “kai” and “kai,” “ha,” and “ka.” The resulting target recognition data is “kai.” In some embodiments, when the mouth shape results are in conflict with the speech processing results, the mouth shape results are used. As an example, if the acoustic model provides only “ha” and “ka” and not “kai,” the device uses the captured mouth shape information to determine what was said.

In some embodiments, other feature information, e.g., gesture information, key operation information, etc., is set according to actual conditions.

Please note that, in some embodiments, in addition to adding other feature information, adding to the recognition process flow, i.e., recognizing other candidate recognition data matched with other feature information, and using first candidate recognition data, second candidate recognition data, and other candidate recognition data to determine the target recognition data is possible.

For example, a user sets an unlocking code when unlocking a mobile device screen as the spoken word “jiesuo [unlock]” and the gesture information “W.” For example, the user can draw a “W” using his finger in front of the device's video camera, and the device will capture the gesture and recognize the gesture in addition to the spoken word. When unlocking the mobile device, the speech signal input by the user is recognized as “jiesuo [unlock]” or “jieshuo [explain].” The user's mouth-shape is recognized as “jiesuo [unlock],” and the gesture information input by the user is recognized as “W.” Therefore, based on the combination of the speech recognition result, the mouth-shape recognition result, and the gesture information, the target recognition data corresponds to the spoken word “jiesuo [unlock]” and the gesture information “W.” Therefore, the mobile device screen can be unlocked successfully.

In 150, the server sends the target recognition data to the client.

In some embodiments, after the client receives the target recognition data, the client performs an operation based on the received target recognition data.

In some embodiments, this operation includes displaying the target recognition data. For example, a user inputs speech signals while editing a text message or chatting. The target recognition data can be displayed in the text message or in a chat window of an instant messaging tool.

In some embodiments, the operation includes executing the target recognition data. For example, a user inputs the speech signals “da kai yin yue bo fang qi [open music player].” Upon recognizing that the target recognition data corresponds to “open music player,” the mobile device can perform the “open music player” operation and turn on the music player.

In some embodiments, the server recognizes first candidate recognition data matched with user feature image signals sent by the client and recognizes second candidate recognition data matched with speech signals sent by the client. The server then determines target recognition data and then sends the target recognition data to the client. By combining image processing technology with speech recognition technology, the server reduces interference, such as soft speech or environment noise, at the time of speech signal input and increases the accuracy rate of speech recognition.

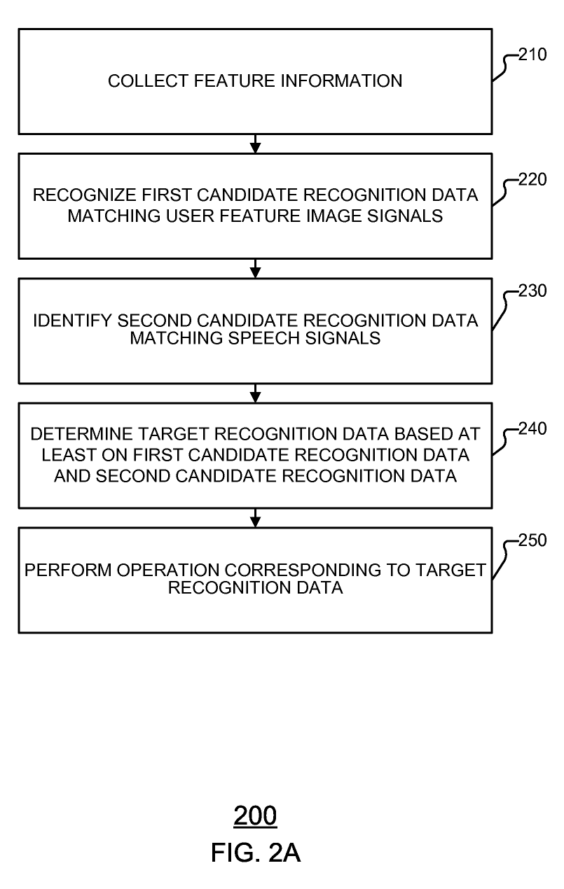

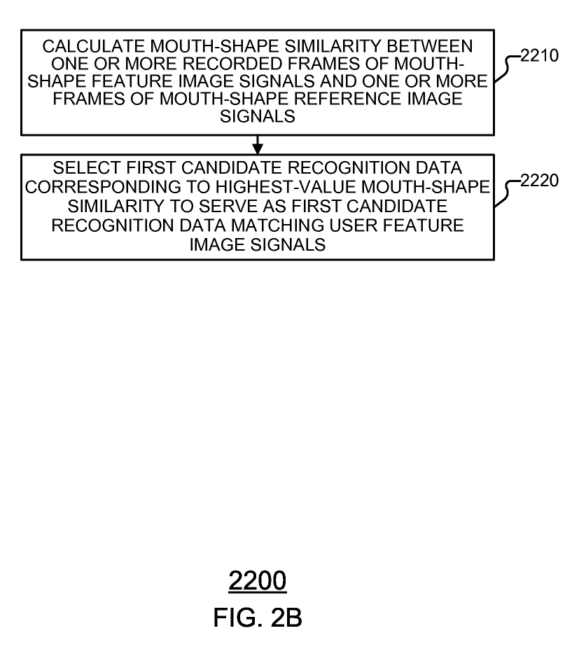

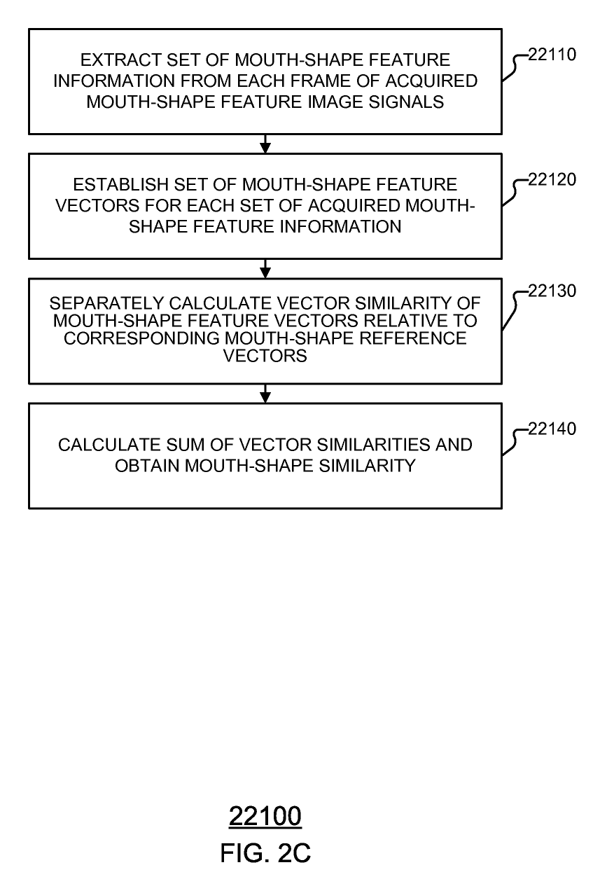

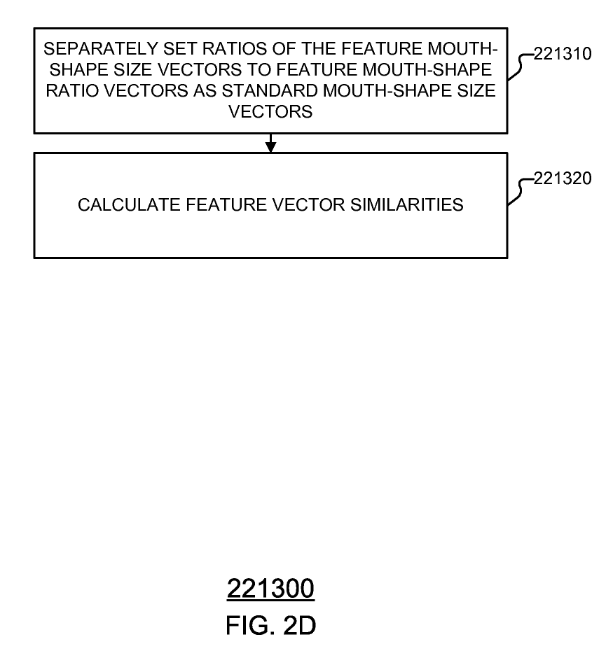

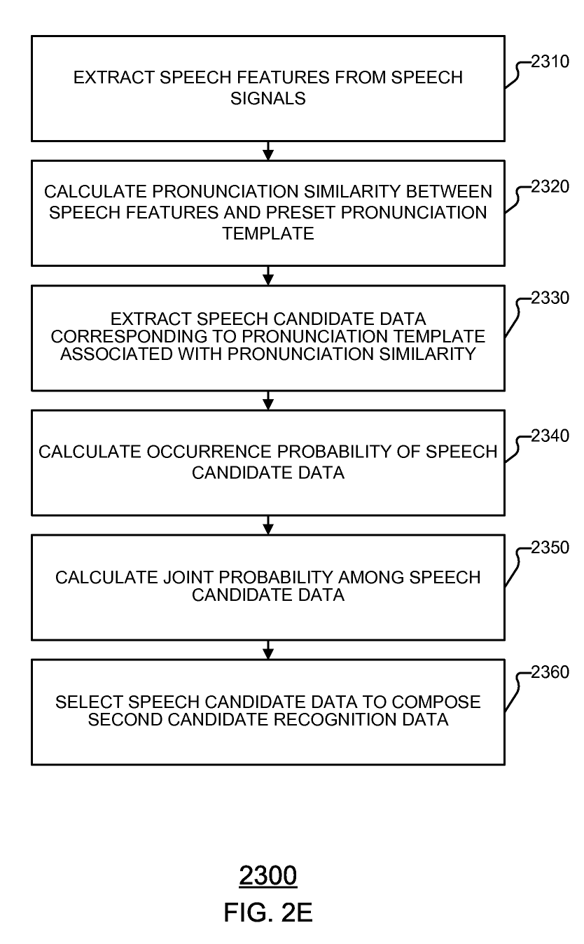

FIG. 2A is a flowchart of another embodiment of a process for speech input. In some embodiments, the process 200 is implemented by a server 5100 of FIG. 5A or by a device such as a mobile phone, a tablet, etc. In the following discussion, a server-based implementation is described, but a client-implementation is also possible in some embodiments.

In 210, the server collects feature information, the feature information including speech signals and user feature image signals.

In some embodiments, the user feature image signals include one or more frames of mouth-shape feature image signals recorded when the speech signals were input.

In 220, the server recognizes first candidate recognition data matching the user feature image signals.

FIG. 2B is a flowchart of another embodiment of a process for recognizing first candidate recognition data matching user feature image signals. In some embodiments, the process 2200 is an implementation of operation 220 of FIG. 2A and comprises:

In 2210, the server calculates a mouth-shape similarity between one or more frames of recorded mouth-shape feature image signals and one or more frames of mouth-shape reference image signals.

In some embodiments, each frame of the mouth-shape reference signals corresponds to a set of mouth-shape reference vectors.

In some embodiments, each mouth-shape reference vector includes: a reference mouth-shape size vector element, a reference mouth-shape ratio vector element, a reference teeth visibility vector element, a reference teeth ratio vector element, a reference tongue visibility vector element, a reference tongue ratio vector element, or any combination thereof.

In some embodiments, the reference mouth-shape size vector element identifies a size of an area of a mouth-shape region in the mouth-shape reference image signals.

In some embodiments, the reference teeth visibility vector element identifies whether a teeth region has been recognized in the mouth-shape reference image signals.

In some embodiments, the reference mouth-shape ratio vector element identifies a ratio of an area of a mouth-shape region in the mouth-shape reference image signals to an area of a preset standard mouth-shape region.

In some embodiments, the reference teeth ratio vector element identifies a ratio of a teeth region to a mouth-shape region in the mouth-shape reference image signals.

In some embodiments, the reference tongue visibility vector element identifies whether a tongue region has been recognized in the mouth-shape reference image signals.

In some embodiments, the reference tongue ratio vector element identifies a ratio of a tongue region to a mouth-shape region in the mouth-shape reference image signals.

FIG. 2C is a flowchart of another embodiment of a process for calculating a mouth-shape similarity between a frame of mouth-shape feature image signals and a frame of mouth-shape reference image signals. In some embodiments, the process 22100 is an implementation of operation 2210 of FIG. 2B and comprises:

In 22110, the server extracts a set of mouth-shape feature information from each frame of mouth-shape feature image signals.

In 22120, the server establishes a set of mouth-shape feature vectors for each set of mouth-shape feature information.

In some embodiments, each mouth-shape feature vector includes a feature mouth-shape size vector element, a feature mouth-shape ratio vector element, a feature teeth visibility vector element, a feature teeth ratio vector element, a feature tongue visibility vector element, a feature tongue ratio vector element, or any combination thereof.

In some embodiments, the feature mouth-shape size vector element identifies a size of an area of a mouth-shape region in the mouth-shape feature image signals.

In some embodiments, the feature mouth-shape ratio vector element identifies a ratio of an area of a mouth-shape region in the mouth-shape feature image signals to an area of a preset standard mouth-shape region.

In some embodiments, the feature teeth visibility vector element identifies whether a teeth region has been recognized in the mouth-shape feature image signals.

In some embodiments, the feature teeth ratio vector element identifies a ratio of a teeth region to a mouth-shape region in the mouth-shape feature image signals.

In some embodiments, the feature tongue visibility vector element identifies whether a tongue region has been recognized in the mouth-shape feature image signals.

In some embodiments, the feature tongue ratio vector element identifies a ratio of a tongue region to a mouth-shape region in the mouth-shape feature image signals.

In 22130, the server separately calculates a vector similarity of the mouth-shape feature vectors to corresponding mouth-shape reference vectors.

FIG. 2D is a flowchart of another embodiment of a process for calculating a vector similarity of mouth-shape feature vectors to corresponding mouth-shape reference vectors. In some embodiments, the process 221300 corresponds to operation 22130 of FIG. 2C and comprises:

In some embodiments, in 221310, the server separately sets ratios of feature mouth-shape size vectors to feature mouth-shape ratio vectors as standard mouth-shape size vectors.

In some embodiments, in 221320, the server calculates feature vector similarities at least based on the vector elements. In some embodiments, the similarity is determined for the standard mouth-shape size vector element, the feature teeth visibility vector element, the feature teeth ratio vector element, the feature tongue visibility vector element, and the feature tongue ratio vector element relative to the reference mouth-shape size vector element, the reference teeth visibility vector element, the reference teeth ratio vector element, the reference tongue visibility vector element, and the reference tongue ratio vector element by computing the distance of the vectors (e.g., subtracting each pair of elements, squaring the differences, summing the squared results, and taking the square roots).

Referring back to FIG. 2C, in 22140, the server calculates a sum of the vector similarities and obtains a mouth-shape similarity based on the sum of the vector similarities.

In 2220, the server selects first candidate recognition data corresponding to the highest-value mouth-shape similarity to serve as the first candidate recognition data matching the user feature image signals.

Referring back to FIG. 2A, in 230, the server identifies second candidate recognition data matching the speech signals.

FIG. 2E is a flowchart of another embodiment of a process for identifying second candidate recognition data matching speech signals. In some embodiments, the process 2300 is an implementation of operation 230 of FIG. 2A and comprises:

In 2310, the server extracts speech features from the speech signals.

In 2320, the server calculates a pronunciation similarity between the speech features and a preset pronunciation template.

In 2330, in the event that the pronunciation similarity is greater than a preset similarity threshold value, the server extracts speech candidate data corresponding to the pronunciation template associated with the pronunciation similarity.

In 2340, the server calculates an occurrence probability of the speech candidate data.

In 2350, in the event that the occurrence probability is greater than a preset first probability threshold value, the server calculates a joint probability among the speech candidate data.

In 2360, in the event that the joint probability is greater than a preset second probability threshold value, the server selects the speech candidate data to compose the second candidate recognition data.

Referring back to FIG. 2A, in 240, the server determines target recognition data based at least on the first candidate recognition data and the second candidate recognition data.

In some embodiments, the determining of the target recognition data based at least on the first candidate recognition data and the second candidate recognition data includes performing intersection processing on the first candidate recognition data and the second candidate recognition data to obtain the target recognition data.

In some embodiments, the process 200 further includes:

In 250, the server performs an operation corresponding to the target recognition data.

In addition to increasing speech recognition accuracy rates, the process 200 reduces recognition of erroneous target recognition data. When performing operations corresponding to the target recognition data, erroneous operations are reduced and accuracy rates of voice control command execution are increased. On one hand, the process 200 can reduce operations performed when a user re-inputs feature information, etc., while making user operations more convenient. On the other hand, the process 200 can reduce responses from the client relating to user-issued feature information and consumption of client system resources.

The embodiment of the process 200 is further explained using examples of various application scenarios below:

In application scenario 1, as applied to a personal computer, a microphone and a video camera are installed in a computer for collecting speech signals emitted from the user and for inputting the mouth-shape feature image signals for the speech signals. Video equipment can be connected to or built into the computer. In some embodiments, the computer user periodically (e.g., every month) or occasionally (when another user borrows the computer) updates a “power on computer” command.

Assume that the current “power on computer” command is spoken words “Open Sesame” and the gesture “V.” For example, the user can draw a “V” using his finger in front of the device's video camera, and the device will capture the gesture and recognize the gesture in addition to the spoken words. When speech signals input by the user are recognized as “Open Sesame,” the mouth-shape variations of the user are recognized as “Open Sesame,” and the user's gestures are recognized as the gesture “V,” a match is made with the current “power on computer” command, and the computer can be powered on in the event that the computer is in a sleep mode or power saving mode where the computer is running a process waiting for the user's request.

While ensuring security, application scenario 1 increases the accuracy rate of speech recognition, resulting in a lower cost of switching and inputting “power on computer” commands and increasing a user's operating convenience.

In application scenario 2, as applied to a smart home, a microphone and a video camera are installed in a mobile device and are used to collect speech signals emitted by a user and to input mouth-shape feature image signals for the speech signals.

In the summer, while on the way home, a user wishes to input speech signals into his mobile device. When the speech signals input by the user are recognized as “turn on air conditioning 26 degrees,” and the user's mouth-shape variations are recognized as “turn on air conditioning 26 degrees,” the mobile device identifies the “cool to 26° C.” instruction, which corresponds to the recognized speech data. The mobile device sends the “cool to 26° C.” instruction to the air conditioner in the user's home. When the user returns home, the home is already cooled to a relatively comfortable temperature.

In increasing speech recognition accuracy, the present application scenario 2 provides the possibility of a smart home voice control and increases the convenience of user operation.

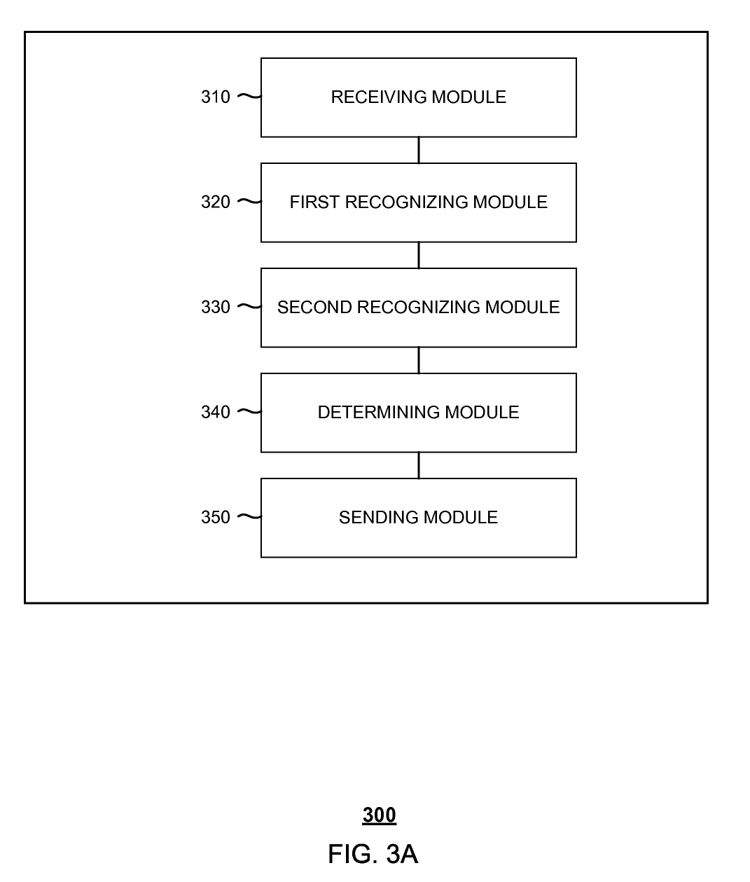

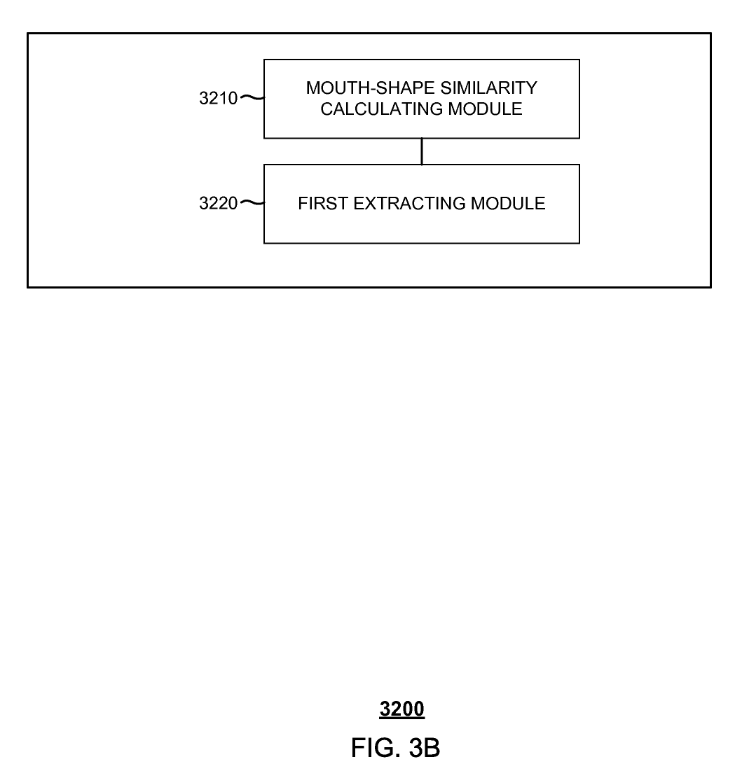

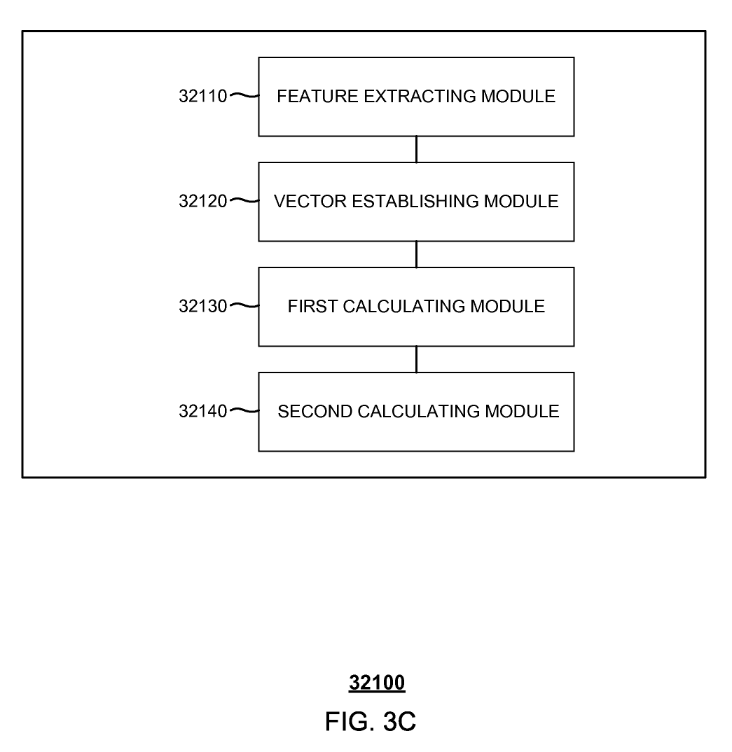

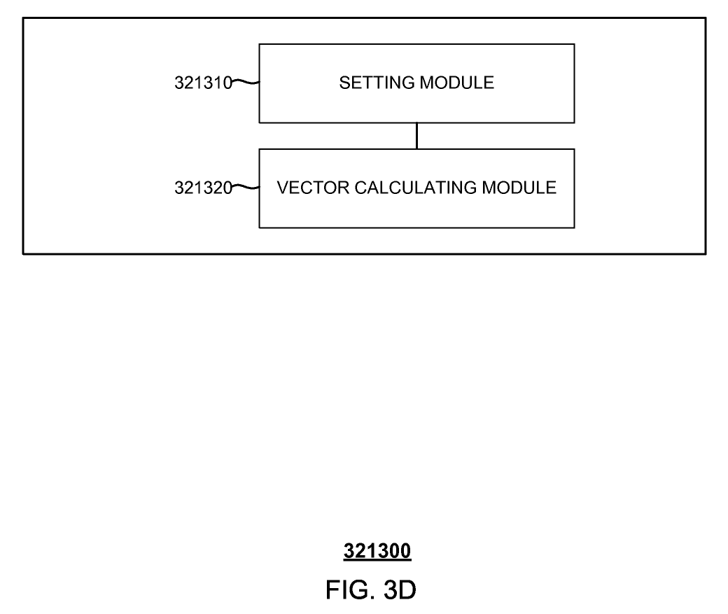

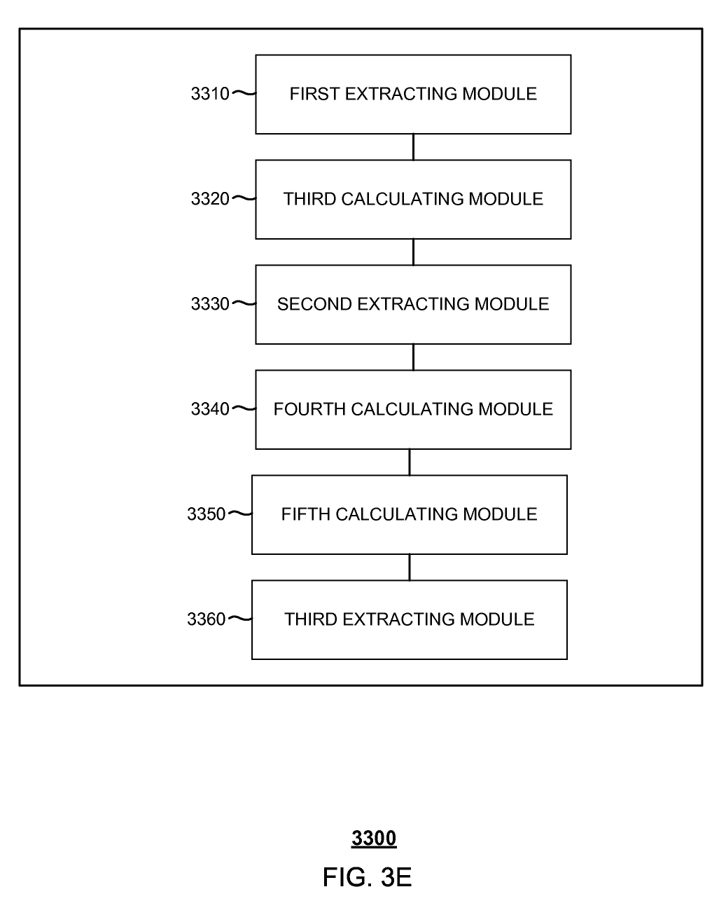

FIG. 3A is a structural block diagram of an embodiment of a device for speech input. In some embodiments, the device 300 performs the process 100 of FIG. 1A and comprises: a receiving module 310, a first recognizing module 320, a second recognizing module 330, a determining module 340, and a sending module 350.

In some embodiments, the receiving module 310 receives feature information sent by a client, the feature information including speech signals and user feature image signals.

In some embodiments, the first recognizing module 320 recognizes first candidate recognition data matching the user feature image signals.

In some embodiments, the second recognizing module 330 recognizes second candidate recognition data matching the speech signals.

In some embodiments, the determining module 340 determines target recognition data based at least on the first candidate recognition data and the second candidate recognition data.

In some embodiments, the sending module 350 sends the target recognition data to the client.

In some embodiments, the user feature image signals include one or more frames of mouth-shape feature image signals recorded when the speech signals were input.

FIG. 3B is a structural block diagram of an embodiment of a first recognizing module. In some embodiments, the first recognizing module 3200 is an implementation of the first recognizing module 320 of FIG. 3A and comprises: a mouth-shape similarity calculating module 3210 and a first extracting module 3220.

In some embodiments, the mouth-shape similarity calculating module 3210 calculates a mouth-shape similarity between the one or more frames of mouth-shape feature image signals and the one or more frames of mouth-shape reference image signals.

In some embodiments, the first extracting module 3220 extracts first candidate recognition data corresponding to the highest-value mouth-shape similarity to serve as the first candidate recognition data matching the user feature image signals.

In some embodiments, each frame of the mouth-shape reference image signals corresponds to a set of mouth-shape reference vectors.

FIG. 3C is a structural block diagram of an embodiment of a first mouth-shape similarity calculating module. In some embodiments, the mouth-shape similarity calculating module 32100 is an implementation of the mouth-shape similarity calculating module 3210 of FIG. 3B and comprises: a feature extracting module 32110, a vector establishing module 32120, a first calculating module 32130, and a second calculating module 32140

In some embodiments, the feature extracting module 32110 extracts a set of mouth-shape feature information from each frame of the mouth-shape feature image signals.

In some embodiments, the vector establishing module 32120 establishes a set of mouth-shape feature vectors for each set of mouth-shape feature information.

In some embodiments, the first calculating module 32130 separately calculates a vector similarity of the mouth-shape feature vectors to corresponding mouth-shape reference vectors.

In some embodiments, the second calculating module 32140 calculates a sum of the vector similarities and obtains a mouth-shape similarity based on the sum of the vector similarities.

In some embodiments, each mouth-shape feature vector includes: a feature mouth-shape size vector element, a feature mouth-shape ratio vector element, a feature teeth visibility vector element, a feature teeth ratio vector element, a feature tongue visibility vector element, a feature tongue ratio vector element, or any combination thereof.

In some embodiments, the feature mouth-shape size vector element identifies a size of an area of a mouth-shape region in the mouth-shape feature image signals.

In some embodiments, the feature mouth-shape ratio vector element identifies a ratio of an area of a mouth-shape region in the mouth-shape feature image signals to an area of a preset standard mouth-shape region.

In some embodiments, the feature teeth visibility vector element identifies whether a teeth region has been recognized in the mouth-shape feature image signals.

In some embodiments, the feature teeth ratio vector element identifies a ratio of a teeth region to a mouth-shape region in the mouth-shape feature image signals.

In some embodiments, the feature tongue visibility vector element identifies whether a tongue region has been recognized in the mouth-shape feature image signals.

In some embodiments, the feature tongue ratio vector element identifies a ratio of a tongue region to a mouth-shape region in the mouth-shape feature image signals.

In some embodiments, each mouth-shape reference vector includes a reference mouth-shape size vector element, a reference mouth-shape ratio vector element, a reference teeth visibility vector element, a reference teeth ratio vector element, a reference tongue visibility vector element, a reference tongue ratio vector element, or any combination thereof.

In some embodiments, the reference mouth-shape size vector element identifies a size of an area of a mouth-shape region in the mouth-shape reference image signals.

In some embodiments, the reference teeth visibility vector element identifies whether a teeth region has been recognized in the mouth-shape reference image signals.

In some embodiments, the reference mouth-shape ratio vector element identifies a ratio of an area of the mouth-shape region in the mouth-shape reference image signals to an area of a preset standard mouth-shape region.

In some embodiments, the reference teeth ratio vector element identifies a ratio of a teeth region to a mouth-shape region in the mouth-shape reference image signals.

In some embodiments, the reference tongue visibility vector element identifies whether a tongue region has been recognized in the mouth-shape reference image signals.

In some embodiments, the reference tongue ratio vector element identifies a ratio of a tongue region to a mouth-shape region in the mouth-shape reference image signals.

FIG. 3D is a structural block diagram of an embodiment of a first calculating module. In some embodiments, the first calculating module 321300 is an implementation of the first calculating module 32130 of FIG. 3C and comprises: a setting module 321310 and a vector calculating module 321320.

In some embodiments, the setting module 321310 separately sets ratios of the feature mouth-shape size vectors to the feature mouth-shape ratio vectors as the standard mouth-shape size vectors.

In some embodiments, the vector calculating module 321320 calculates feature vector similarities based at least on the vector elements. In some embodiments, the similarity is determined for the standard mouth-shape size vector element, the feature teeth visibility vector element, the feature teeth ratio vector element, the feature tongue visibility vector element, and the feature tongue ratio vector element relative to the reference mouth-shape size vector element, the reference teeth visibility vector element, the reference teeth ratio vector element, the reference tongue visibility vector element, and the reference tongue ratio vector element by computing the distance of the vectors (e.g., subtracting each pair of elements, squaring the differences, summing the squared results, and taking the square roots.).

FIG. 3E is a structural block diagram of an embodiment of a second recognizing module. In some embodiments, the second recognizing module 3300 is an implementation of the second recognizing module 330 of FIG. 3A and comprises: a first extracting module 3310, a third calculating module 3320, a second extracting module 3330, a fourth calculating module 3340, a fifth calculating module 3350, and a third extracting module 3360.

In some embodiments, the first extracting module 3310 extracts speech features from the speech signals.

In some embodiments, the third calculating module 3320 calculates a pronunciation similarity between the speech features and a preset pronunciation template.

In some embodiments, in the event that the pronunciation similarity is greater than a preset similarity threshold value, the second extracting module 3330 extracts speech candidate data corresponding to the pronunciation template associated with the pronunciation similarity.

In some embodiments, the fourth calculating module 3340 calculates an occurrence probability of the speech candidate data.

In some embodiments, in the event that the occurrence probability is greater than a preset first probability threshold value, the fifth calculating module 3350 calculates a joint probability among the speech candidate data.

In some embodiments, in the event that the joint probability is greater than a preset second probability threshold value, the third extracting module 3360 extracts the speech candidate data to compose second candidate recognition data.

Referring back to FIG. 3A, in some embodiments, the second recognizing module 330 performs intersection processing on the first candidate recognition data and the second candidate recognition data to obtain the target recognition data.

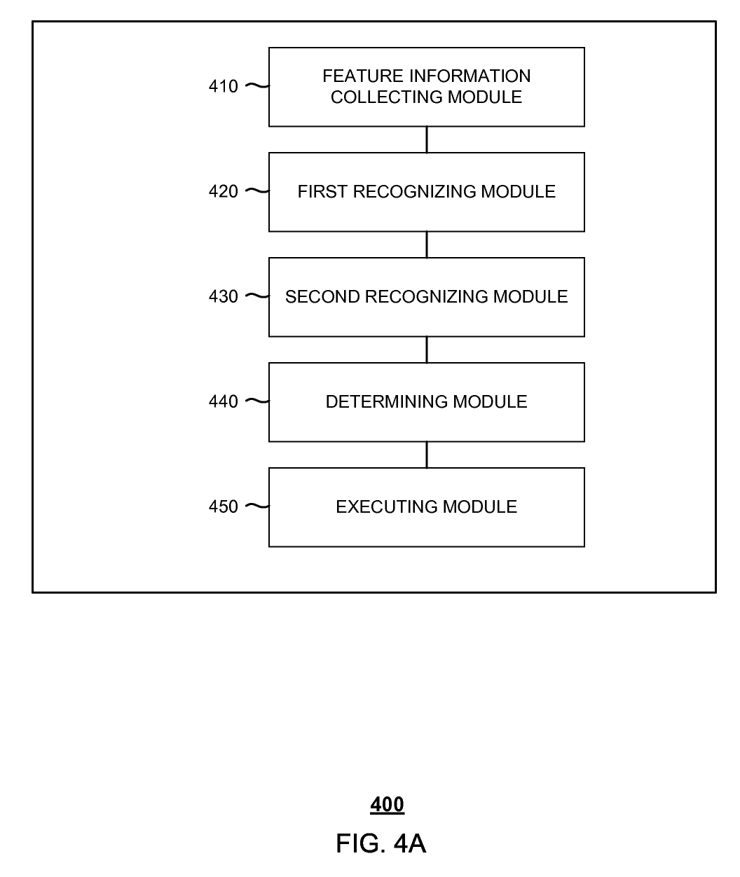

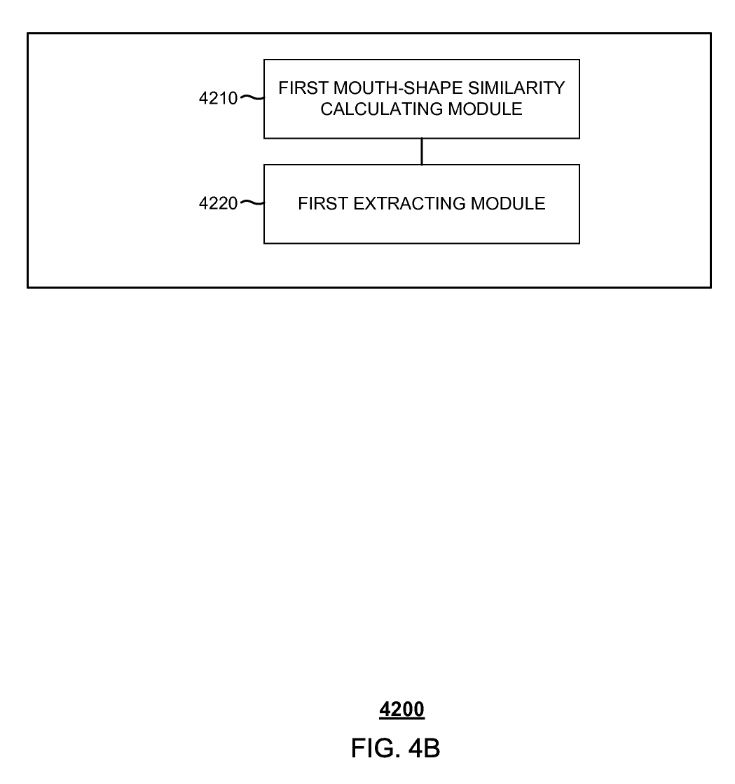

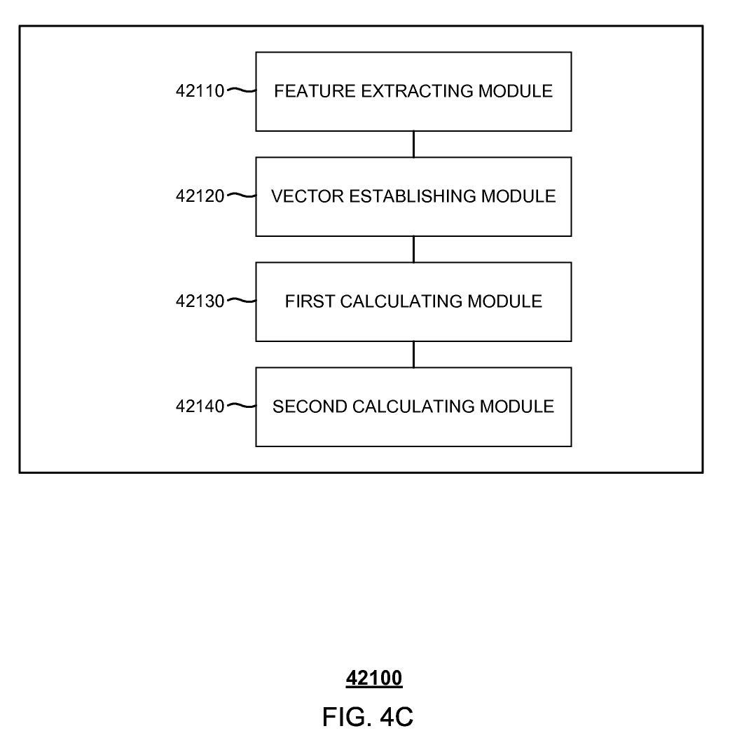

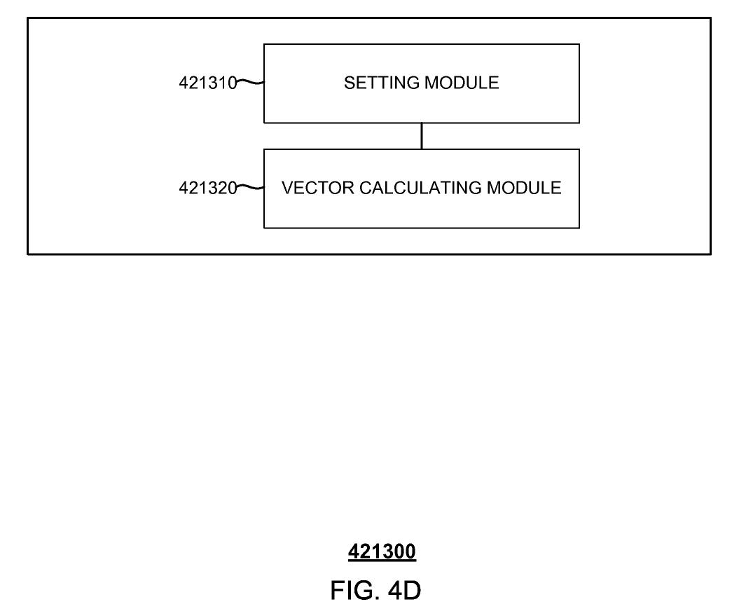

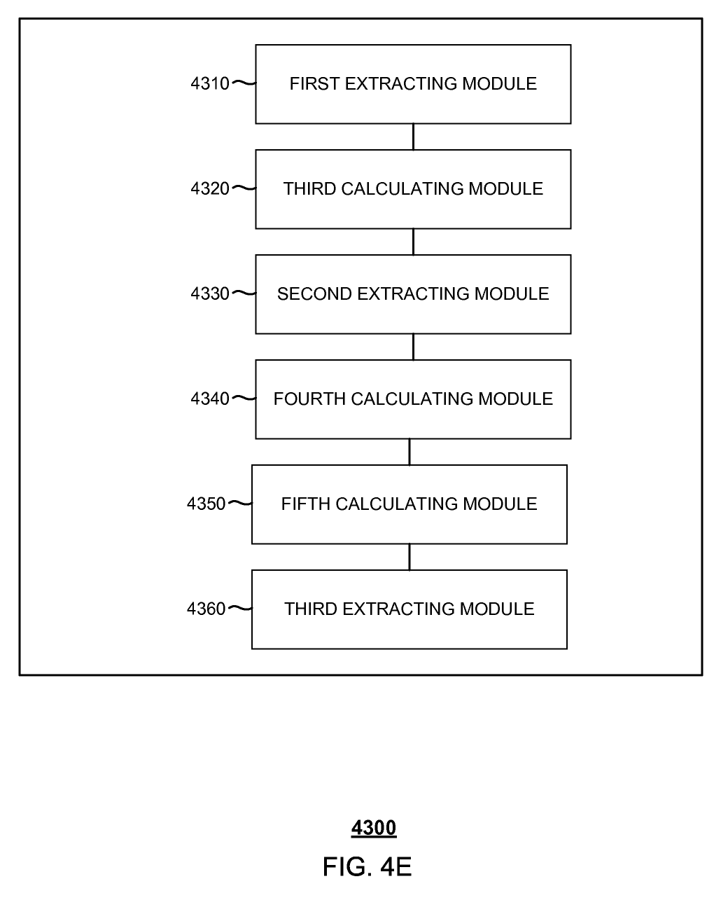

FIG. 4A is a structural block diagram of another embodiment of a device for speech input. In some embodiments, the device 400 performs the process 200 of FIG. 2A and comprises: a feature information collecting module 410, a first recognizing module 420, a second recognizing module 430, and a determining module 440.

In some embodiments, the feature information collecting module 410 collects feature information, the feature information including speech signals and user feature image signals.

In some embodiments, the first recognizing module 420 recognizes first candidate recognition data matching the user feature image signals.

In some embodiments, the second recognizing module 430 recognizes second candidate recognition data matching the speech signals.

In some embodiments, the determining module 440 determines target recognition data based at least on the first candidate recognition data and the second candidate recognition data.

In some embodiments, the device 400 further comprises an executing module 450.

In some embodiments, the executing module 450 performs an operation corresponding to the target recognition data.

In some embodiments, the user feature image signals include one or more frames of mouth-shape feature image signals recorded when the speech signals were input.

FIG. 4B is a structural block diagram of another embodiment of a first recognizing module. In some embodiments, the first recognizing module 4200 is an implementation of the first recognizing module 420 of FIG. 4A and comprises: a first mouth-shape similarity calculating module 4210 and a first extracting module 4220.

In some embodiments, the first mouth-shape similarity calculating module 4210 calculates a mouth-shape similarity between the one or more frames of the mouth-shape feature image signals and the one or more frames of mouth-shape reference image signals.

In some embodiments, the first extracting module 4220 extracts the first candidate recognition data corresponding to the highest-value mouth-shape similarity to serve as the first candidate recognition data matching the user feature image signals.

In some embodiments, each frame of the mouth-shape reference image signals corresponds to a set of mouth-shape reference vectors.

FIG. 4C is a structural block diagram of another embodiment of a first mouth-shape similarity calculating module. In some embodiments, the first mouth-shape similarity calculating module 42100 is an implementation of the first mouth-shape similarity calculating module 4210 of FIG. 4B and comprises: a feature extracting module 42110, a vector establishing module 42120, a first calculating module 42130, and a second calculating module 42140.

In some embodiments, the feature extracting module 42110 extracts a set of mouth-shape feature information from each frame of the mouth-shape feature image signals.

In some embodiments, the vector establishing module 42120 establishes a set of mouth-shape feature vectors for each set of mouth-shape feature information.

In some embodiments, the first calculating module 42130 separately calculates a vector similarity of the mouth-shape feature vectors to corresponding mouth-shape reference vectors.

In some embodiments, the second calculating module 42140 calculates a sum of the vector similarities and obtains a mouth-shape similarity based on the sum of the vector similarities.

In some embodiments, each mouth-shape feature vector includes: a feature mouth-shape size vector element, a feature mouth-shape ratio vector element, a feature teeth visibility vector element, a feature teeth ratio vector element, a feature tongue visibility vector element, a feature tongue ratio vector element, or any combination thereof.

In some embodiments, the feature mouth-shape size vector element identifies a size of an area of a mouth-shape region in the mouth-shape feature image signals.

In some embodiments, the feature mouth-shape ratio vector element identifies a ratio of an area of a mouth-shape region in the mouth-shape feature image signals to an area of a preset standard mouth-shape region.

In some embodiments, the feature teeth visibility vector element identifies whether a teeth region has been recognized in the mouth-shape feature image signals.

In some embodiments, the feature teeth ratio vector element identifies a ratio of a teeth region to a mouth-shape region in the mouth-shape feature image signals.

In some embodiments, the feature tongue visibility vector element identifies whether a tongue region has been recognized in the mouth-shape feature image signals.

In some embodiments, the feature tongue ratio vector element identifies a ratio of a tongue region to a mouth-shape region in the mouth-shape feature image signals.

In some embodiments, each mouth-shape reference vector includes: a reference mouth-shape size vector element, a reference mouth-shape ratio vector element, a reference teeth visibility vector element, a reference teeth ratio vector element, a reference tongue visibility vector element, a reference tongue ratio vector element, or any combination thereof.

In some embodiments, the reference mouth-shape size vector element identifies a size of an area of a mouth-shape region in the mouth-shape reference image signals.

In some embodiments, the reference teeth visibility vector element identifies whether a teeth region has been recognized in the mouth-shape reference image signals.

In some embodiments, the reference mouth-shape ratio vector element identifies a ratio of an area of a mouth-shape region in the mouth-shape reference image signals to an area of a preset standard mouth-shape region.

In some embodiments, the reference teeth ratio vector element identifies a ratio of a teeth region to a mouth-shape region in the mouth-shape reference image signals.

In some embodiments, the reference tongue visibility vector element identifies whether a tongue region has been recognized in the mouth-shape reference image signals.

In some embodiments, the reference tongue ratio vector element identifies a ratio of a tongue region to a mouth-shape region in the mouth-shape reference image signals.

FIG. 4D is a structural block diagram of another embodiment of a first calculating module. In some embodiments, the first calculating module 421300 is an implementation of the first calculating module 42130 of FIG. 4C and comprises: a setting module 421310 and a vector calculating module 421320.

In some embodiments, the setting module 421310 separately sets ratios of the feature mouth-shape size vectors to the feature mouth-shape ratio vectors as the standard mouth-shape size vectors.

In some embodiments, the vector calculating module 421320 calculates feature vector similarities based at least on the vector elements. In some embodiments, the similarity is determined for the standard mouth-shape size vector element, the feature teeth visibility vector element, the feature teeth ratio vector element, the feature tongue visibility vector element, and the feature tongue ratio vector element relative to the reference mouth-shape size vector element, the reference teeth visibility vector element, the reference teeth ratio vector element, the reference tongue visibility vector element, and the reference tongue ratio vector element by computing the distance of the vectors (e.g., subtracting each pair of elements, squaring the differences, summing the squared results, and taking the square roots.).

FIG. 4E is a structural block diagram of another embodiment of a second recognizing module. In some embodiments, the second recognizing module 4300 is an implementation of the second recognizing module 430 of FIG. 4A and comprises: a first extracting module 4310, a third calculating module 4320, a second extracting module 4330, a fourth calculating module 4340, a fifth calculating module 4350, and a third extracting module 4360.

In some embodiments, the first extracting module 4310 extracts speech features from the speech signals.

In some embodiments, the third calculating module 4320 calculates a pronunciation similarity between the speech features and a preset pronunciation template.

In some embodiments, in the event that the pronunciation similarity is greater than a preset similarity threshold value, the second extracting module 4330 extracts the speech candidate data corresponding to the pronunciation template associated with the pronunciation similarity.

In some embodiments, the fourth calculating module 4340 calculates an occurrence probability of the speech candidate data.

In some embodiments, in the event that the occurrence probability is greater than a preset first probability threshold value, the fifth calculating module 4350 calculates a joint probability among the speech candidate data.

In some embodiments, in the event that the joint probability is greater than a preset second probability threshold value, the third extracting module 4360 extracts the speech candidate data to compose second candidate recognition data.

Referring back to FIG. 4A, in some embodiments, the determining module 440 performs intersection processing on the first candidate recognition data and the second candidate recognition data to obtain target recognition data.

FIG. 5A is a structural block diagram of an embodiment of a system for speech input. In some embodiments, the speech input system 500 includes a server 5100 connected to a client 5200 via a network 5300.

In some embodiments, the server 5100 includes: a first receiving module 5110, a first recognizing module 5120, a second recognizing module 5130, a determining module 5140, and a first sending module 5150.

In some embodiments, the first receiving module 5110 receives feature information sent by a client, the feature information including speech signals and user feature image signals.

In some embodiments, the first recognizing module 5120 recognizes first candidate recognition data matching the user feature image signals.

In some embodiments, the second recognizing module 5130 recognizes second candidate recognition data matching the speech signals.

In some embodiments, the determining module 5140 determines target recognition data based at least on the first candidate recognition data and the second candidate recognition data.

In some embodiments, the first sending module 5150 sends the target recognition data to the client.

In some embodiments, the client 5200 includes: a feature information collecting module 5210, a second sending module 5220, and a second receiving module 5230.

In some embodiments, the feature information collecting module 5210 collects feature information, the feature information including speech signals and user feature image signals.

In some embodiments, the second sending module 5220 sends the feature information to the server.

In some embodiments, the second receiving module 5230 receives the target recognition data sent by the server.

In some embodiments, the client 5200 further includes: an executing module 5240.

In some embodiments, the executing module 5240 performs an operation corresponding to the target recognition data.

In some embodiments, the user feature image signals include one or more frames of mouth-shape feature image signals recorded when the speech signals were input.

FIG. 5B is a structural block diagram of another embodiment of a first recognizing module. In some embodiments, the first recognizing module 51200 is an implementation of the first recognizing module 5120 of FIG. 5A and comprises: a first mouth-shape similarity calculating module 51210 and a first extracting module 51220.

In some embodiments, the first mouth-shape similarity calculating module 51210 calculates a mouth-shape similarity between the one or more frames of mouth-shape feature image signals and the one or more frames of mouth-shape reference image signals.

In some embodiments, the first extracting module 51220 extracts first candidate recognition data corresponding to the highest-value mouth-shape similarity to serve as the first candidate recognition data matching the user feature image signals.

In some embodiments, each frame of mouth-shape reference image signals corresponds to a set of mouth-shape reference vectors.

FIG. 5C is a structural block diagram of another embodiment of a first mouth-shape similarity calculating module. In some embodiments, the first mouth-shape similarity calculating module 512100 is an implementation of the first mouth-shape similarity calculating module 51210 of FIG. 5B and comprises: a feature extracting module 512110, a vector establishing module 512120, a first calculating module 512130, and a second calculating module 512140.

In some embodiments, the feature extracting module 512110 extracts a set of mouth-shape feature information from each frame of mouth-shape feature image signals.

In some embodiments, the vector establishing module 512120 establishes a set of mouth-shape feature vectors for each set of mouth-shape feature information.

In some embodiments, the first calculating module 512130 separately calculates a vector similarity of the mouth-shape feature vectors to the corresponding mouth-shape reference vectors.

In some embodiments, the second calculating module 512140 calculates a sum of the vector similarities and obtains a mouth-shape similarity based on the sum of the vector similarities.

In some embodiments, each mouth-shape feature vector includes: a feature mouth-shape size vector element, a feature mouth-shape ratio vector element, a feature teeth visibility vector element, a feature teeth ratio vector element, a feature tongue visibility vector element, a feature tongue ratio vector element, or any combination thereof.

In some embodiments, the feature mouth-shape size vector element identifies a size of an area of a mouth-shape region in the mouth-shape feature image signals.

In some embodiments, the feature mouth-shape ratio vector element identifies a ratio of an area of a mouth-shape region in the mouth-shape feature image signals to an area of a preset standard mouth-shape region.

In some embodiments, the feature teeth visibility vector element identifies whether a teeth region has been recognized in the mouth-shape feature image signals.

In some embodiments, the feature teeth ratio vector element identifies a ratio of a teeth region to a mouth-shape region in the mouth-shape feature image signals.

In some embodiments, the feature tongue visibility vector element identifies whether a tongue region has been recognized in the mouth-shape feature image signals.

In some embodiments, the feature tongue ratio vector element identifies a ratio of a tongue region to a mouth-shape region in the mouth-shape feature image signals.

In some embodiments, each mouth-shape reference vector includes a reference mouth-shape size vector element, a reference mouth-shape ratio vector element, a reference teeth visibility vector element, a reference teeth ratio vector element, a reference tongue visibility vector element, a reference tongue ratio vector element, or any combination thereof.

In some embodiments, the reference mouth-shape size vector element identifies a size of an area of a mouth-shape region in the mouth-shape reference image signals.

In some embodiments, the reference teeth visibility vector element identifies whether a teeth region has been recognized in the mouth-shape reference image signals.

In some embodiments, the reference mouth-shape ratio vector element identifies a ratio of an area of a mouth-shape region in the mouth-shape reference image signals to an area of a preset standard mouth-shape region.

In some embodiments, the reference teeth ratio vector element identifies a ratio of a teeth region to a mouth-shape region in the mouth-shape reference image signals.

In some embodiments, the reference tongue visibility vector element identifies whether a tongue region has been recognized in the mouth-shape reference image signals.

In some embodiments, the reference tongue ratio vector element identifies a ratio of a tongue region to a mouth-shape region in the mouth-shape reference image signals.

FIG. 5D is a structural block diagram of another embodiment of a first calculating module. In some embodiments, the first calculating module 5121300 is an implementation of the first calculating module 512130 of FIG. 5C and comprises: a setting module 5121310 and a vector calculating module 5121320.

In some embodiments, the setting module 5121310 separately sets ratios of the feature mouth-shape size vectors to the feature mouth-shape ratio vectors as the standard mouth-shape size vectors.

In some embodiments, the vector calculating module 5121320 calculates feature vector similarities based at least on the vector elements. In some embodiments, the similarity is determined for the standard mouth-shape size vector element, the feature teeth visibility vector element, the feature teeth ratio vector element, the feature tongue visibility vector element, and the feature tongue ratio vector element relative to the reference mouth-shape size vector element, the reference teeth visibility vector element, the reference teeth ratio vector element, the reference tongue visibility vector element, and the reference tongue ratio vector element by computing the distance of the vectors (e.g., subtracting each pair of elements, squaring the differences, summing the squared results, and taking the square roots.).

FIG. 5E is a structural block diagram of another embodiment of a second recognizing module. In some embodiments, the second recognizing module 51300 is an implementation of the second recognizing module 5130 of FIG. 5A and comprises: a first extracting module 51310, a third calculating module 51320, a second extracting module 51330, a fourth calculating module 51340, a fifth calculating module 51350, and a third extracting module 51360

In some embodiments, the first extracting module 51310 extracts speech features from the speech signals.

In some embodiments, the third calculating module 51320 calculates a pronunciation similarity between the speech features and a preset pronunciation template.

In some embodiments, in the event that the pronunciation similarity is greater than a preset similarity threshold value, the second extracting module 51330 extracts the speech candidate data corresponding to the pronunciation template associated with the pronunciation similarity.

In some embodiments, the fourth calculating module 51340 calculates an occurrence probability of the speech candidate data.

In some embodiments, in the event that the occurrence probability is greater than a preset first probability threshold value, the fifth calculating module 51350 calculates a joint probability among the speech candidate data.

In some embodiments, in the event that the joint probability is greater than a preset second probability threshold value, the third extracting module 51360 extracts the speech candidate data to compose second candidate recognition data.

Referring back to FIG. 5A, in some embodiments, the second recognizing module 5130 performs intersection processing on the first candidate recognition data and the second candidate recognition data to obtain the target recognition data.

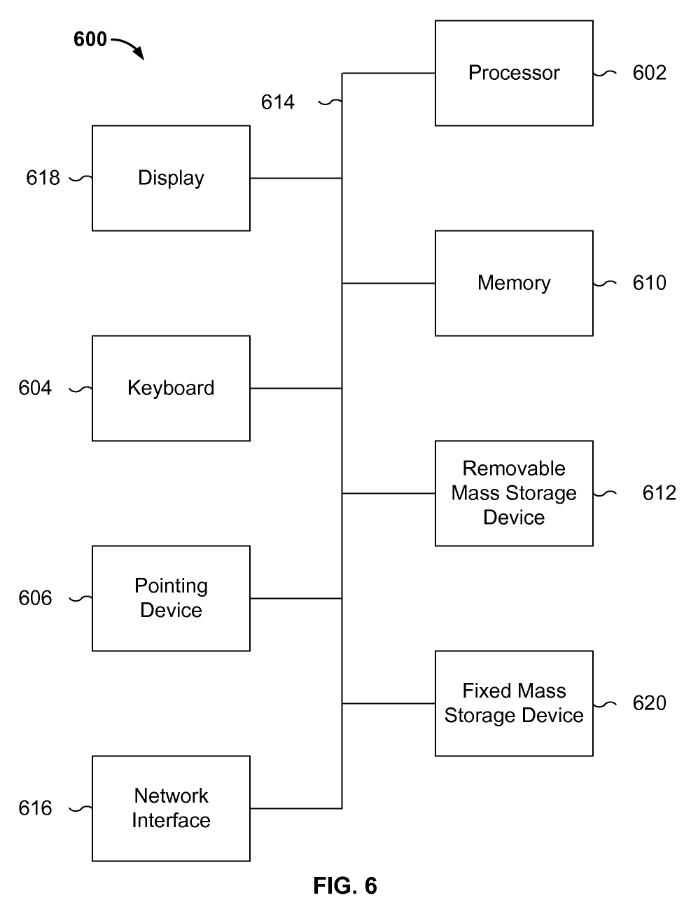

FIG. 6 is a functional diagram illustrating an embodiment of a programmed computer system for processing speech data. As will be apparent, other computer system architectures and configurations can be used to perform speech processing. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618).

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data, and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or uni-directionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storages 612, 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving feature information obtained by a client, the feature information comprising speech signals and user feature image signals;
recognizing first candidate recognition data matching the user feature image signals;
determining target recognition data based at least on the first candidate recognition data; and
outputting the target recognition data.

2. The method as described in claim 1, wherein the user feature image signals comprise one or more frames of mouth-shape feature image signals recorded when the speech signals were input.

3. The method as described in claim 2, wherein:
the first candidate recognition data corresponds to one or more frames of mouth-shape reference image signals; and
the recognizing the first candidate recognition data matching the user feature image signals comprises:
calculating a plurality of mouth-shape similarities between the one or more frames of mouth-shape feature image signals and corresponding sets of one or more frames of mouth-shape reference image signals; and
selecting, among the plurality of mouth-shape similarities, the first candidate recognition data corresponding to a highest-value mouth-shape similarity to serve as the first candidate recognition data matching the user feature image signals.

4. The method as described in claim 3, wherein:
each frame of the mouth-shape reference image signals corresponds to a mouth-shape reference vector; and
the calculating of the mouth-shape similarities between the one or more frames of mouth-shape feature image signals and the one or more frames of mouth-shape reference image signals comprises:
extracting a set of mouth-shape feature information from each frame of the mouth-shape feature image signals;
establishing a mouth-shape feature vector for each set of mouth-shape feature information;
separately calculating a set of vector similarities of the mouth-shape feature vectors to the corresponding mouth-shape reference vectors; and
calculating a sum of the set of vector similarities as the mouth-shape similarity.

5. The method as described in claim 4, wherein:
each mouth-shape feature vector comprises a feature mouth-shape size vector element, a feature mouth-shape ratio vector element, a feature teeth visibility vector element, a feature teeth ratio vector element, a feature tongue visibility vector element, a feature tongue ratio vector element, or any combination thereof;
the feature mouth-shape size vector element identifies a size of an area of a mouth-shape region in the mouth-shape feature image signals;
the feature mouth-shape ratio vector element identifies a ratio of an area of a mouth-shape region in the mouth-shape feature image signals to an area of a preset standard mouth-shape region;
the feature teeth visibility vector element identifies whether a teeth region has been recognized in the mouth-shape feature image signals;
the feature teeth ratio vector element identifies a ratio of a teeth region to a mouth-shape region in the mouth-shape feature image signals;
the feature tongue visibility vector element identifies whether a tongue region has been recognized in the mouth-shape feature image signals; and
the feature tongue ratio vector element identifies a ratio of a tongue region to a mouth-shape region in the mouth-shape feature image signals.

6. The method as described in claim 5, wherein:
each mouth-shape reference vector comprises a reference mouth-shape size vector element, a reference mouth-shape ratio vector element, a reference teeth visibility vector element, a reference teeth ratio vector element, a reference tongue visibility vector element, a reference tongue ratio vector element, or any combination thereof;
the reference mouth-shape size vector element identifies a size of an area of a mouth-shape region in the mouth-shape reference image signals;
the reference teeth visibility vector element identifies whether a teeth region has been recognized in the mouth-shape reference image signals;
the reference mouth-shape ratio vector element identifies a ratio of an area of a mouth-shape region in the mouth-shape reference image signals to an area of a preset standard mouth-shape region;
the reference teeth ratio vector element identifies a ratio of a teeth region to a mouth-shape region in the mouth-shape reference image signals;
the reference tongue visibility vector element identifies whether a tongue region has been recognized in the mouth-shape reference image signals; and
the reference tongue ratio vector element identifies a ratio of a tongue region to a mouth-shape region in the mouth-shape reference image signals.

7. The method as described in claim 6, wherein the separately calculating the set of the vector similarities of the mouth-shape feature vectors to the corresponding mouth-shape reference vectors comprises:
separately setting ratios of the feature mouth-shape size vector elements to the feature mouth-shape ratio vector elements as standard mouth-shape size vector elements; and
calculating feature vector similarities based at least on a standard mouth-shape size vector element, the feature teeth visibility vector element, the feature teeth ratio vector element, the feature tongue visibility vector element, and the feature tongue ratio vector element relating to the reference mouth-shape size vector element, the reference teeth visibility vector element, the reference teeth ratio vector element, the reference tongue visibility vector element, the reference tongue ratio vector element, or any combination thereof.

8. The method as described in claim 1, further comprising:
recognizing second candidate recognition data matching the speech signals.

9. The method as described in claim 8, wherein the recognizing of the second candidate recognition data matching the speech signals comprises:
extracting speech features from the speech signals;
calculating a pronunciation similarity between the speech features and a preset pronunciation template;
in the event that the pronunciation similarity is greater than a preset similarity threshold value, extracting speech candidate data corresponding to the pronunciation template associated with the pronunciation similarity;
calculating an occurrence probability of the speech candidate data;
in the event that the occurrence probability is greater than a preset first probability threshold value, calculating a joint probability among the speech candidate data; and
in the event that the joint probability is greater than a preset second probability threshold value, extracting the speech candidate data to compose the second candidate recognition data.

10. The method as described in claim 8, wherein the determining of the target recognition data based at least on the first candidate recognition data and second candidate recognition data comprises:
performing intersection processing on the first candidate recognition data and the second candidate recognition data to obtain the target recognition data.

11. A method, comprising:
collecting feature information, the feature information including speech signals and user feature image signals;
recognizing first candidate recognition data matching the user feature image signals;
recognizing second candidate recognition data matching the speech signals; and
determining target recognition data based at least on the first candidate recognition data and the second candidate recognition data.

12. The method as described in claim 11, further comprising:
performing an operation corresponding to the target recognition data.

13. The method as described in claim 11, wherein the user feature image signals include one or more frames of mouth-shape feature image signals recorded when the speech signals were input.

14. The method as described in claim 13, wherein:
the first candidate recognition data corresponds to one or more frames of mouth-shape reference image signals; and
the recognizing of the first candidate recognition data matching the user feature image signals comprises:
calculating a mouth-shape similarity between the one or more frames of mouth-shape feature image signals and the one or more frames of mouth-shape reference image signals; and
extracting the first candidate recognition data corresponding to a highest-value mouth-shape similarity to serve as the first candidate recognition data matching the user feature image signals.

15. The method as described in claim 14, wherein:
each frame of the mouth-shape reference image signals corresponds to a set of mouth-shape reference vectors; and
the calculating of the mouth-shape similarity between the one or more frames of mouth-shape feature image signals and the one or more frames of mouth-shape reference image signals comprises:
extracting a set of mouth-shape feature information from each frame of the mouth-shape feature image signals;
establishing a set of mouth-shape feature vectors for each set of mouth-shape feature information;
separately calculating a vector similarity of the mouth-shape feature vectors to the corresponding mouth-shape reference vectors;
calculating a sum of the vector similarities; and
obtaining the mouth-shape similarity based on the sum of the vector similarities.

16. A device, comprising:
a feature information collecting module configured to collect feature information, the feature information including speech signals and user feature image signals;
a first recognizing module configured to recognize first candidate recognition data matching the user feature image signals;
a second recognizing module configured to recognize second candidate recognition data matching the speech signals; and
a determining module configured to determine target recognition data based at least on the first candidate recognition data and the second candidate recognition data.

17. The device as described in claim 16, further comprising:
an executing module configured to execute an operation corresponding to the target recognition data.

18. The device as described in claim 16, wherein the user feature image signals include one or more frames of mouth-shape feature image signals recorded when the speech signals were input.

19. The device as described in claim 18, wherein the first recognizing module comprises:
the mouth-shape similarity calculating module configured to calculate a mouth-shape similarity between the one or more frames of mouth-shape feature image signals and one or more frames of mouth-shape reference image signals; and
a first extracting module configured to extract the first candidate recognition data corresponding to the highest-value mouth-shape similarity to serve as the first candidate recognition data matching the user feature image signals.

20. The device as described in claim 19, wherein:
each frame of the mouth-shape reference image signals corresponds to a set of mouth-shape reference vectors; and
the first mouth-shape similarity calculating module comprises:
a feature extracting module configured to extract a set of mouth-shape feature information from each frame of the mouth-shape feature image signals;
a vector establishing module configured to establish a set of mouth-shape feature vectors for each set of mouth-shape feature information;
a first calculating module configured to separately calculate a vector similarity of the mouth-shape feature vectors to the corresponding mouth-shape reference vectors; and
a second calculating module configured to:
calculate a sum of the vector similarities; and
obtain a mouth-shape similarity based on the sum of the vector similarities.

21. A computer program product being embodied in a tangible non-transitory computer readable storage medium and comprising computer instructions for:
collecting feature information, the feature information including speech signals and user feature image signals;
recognizing first candidate recognition data matching the user feature image signals;
recognizing second candidate recognition data matching the speech signals; and
determining target recognition data based at least on the first candidate recognition data and the second candidate recognition data.

22. A mobile device, comprising:
a microphone configured to capture speech signals from a user operating the mobile device;
a camera configured to capture image signals of the user; and
a processor coupled to the microphone and the camera, the processor configured to:
receive the speech signals and the image signals substantially simultaneously in response to an instruction input from the user; and
determine a target instruction based at least in part on the speech signals and the image signals, wherein the target instruction is to enable the mobile device to perform a particular task.

23. The mobile device of claim 22, wherein the speech signals and the image signals are associated with the mouth of the user.

24. The mobile device of claim 22, wherein the speech signals and the image signals are associated with different organs of the user.
